(19) United States
(12) Patent Application Publication
(10) Pub. No.: US 2015/0227787 A1
(43) Pub. Date: Aug. 13, 2015

(54) PHOTOGRAPH BILLPAY TAGGING

(71) Applicant: Bank of America Corporation, Charlotte, NC (US)

(72) Inventors: Saurabh Mehta, Dallas, TX (US); Donald W. Schoppe, Apex, NC (US); Dingxiang Liu, Charlotte, NC (US); Karan S. Sahni, Dallas, TX (US); Sharon Scanlon, Jersey City, NJ (US); Hood Qaim-Maqami, Jersey City, NJ (US); Pavan K. Chayanam, San Francisco, CA (US)

(73) Assignee: Bank of America Corporation, Charlotte, NC (US)

(21) Appl. No.: 14/178,488

(22) Filed: Feb. 12, 2014

(51) Int. Cl. G06K 9/00; G06Q 20/10; G06F 17/24

(52) U.S. Cl. CPC G06K 9/00449; G06F 17/243; G06Q 20/102

(57) ABSTRACT

Tools for photograph billpay tagging of a digital image are provided. The digital image may correspond to a portion of text positioned upon a medium. The text may correspond to billpay information. The tool may define a graphical reference frame for the digital image. The tool may identify a set of glyphs within the text. The tool may translate a portion of the digital image into an estimated group of characters. The translated portion of the digital image may correspond to at least a part of the set of glyphs. The tool may tag the portion of the digital image with a tag. The tag may be coupled with a billpay input field. The billpay input field may be populated. The billpay input field may be populated with the group of estimated characters. The bill input field may be populated based on the coupling.

### BACKGROUND

Financial institutions have been expanding solutions for online banking. The number of individuals and businesses (“entities”) utilizing online billpay continues to grow.

Some entities prefer to receive statements and bills electronically. Often times, the entity may receive a “paperless” statement through e-mail. Still, some entities prefer the receiving statements and bills in paper form. Some prefer to receive paper statements because it serves to remind them to pay the bill. Others prefer to receive paper statements because they do not trust e-mail, whether for security purposes, filters such as spam, or worries that the bill will not actually arrive. Still, some companies do not offer online statements.

While online billpay has certain benefits and conveniences, and has advanced in technology, some aspects are still inconvenient to users.

A user or entity may desire to receive paper statements or bills, but prefer to pay the bill via online billpay.

Often times, this requires the hassle of entering information into billpay fields.

The data entry for online billpay fields is not only time consuming, but prone to error. This is especially true as more individuals utilize mobile devices for everyday computing.

Thus, online billpay is often an inconvenience to those entities with paper statements.

It would be desirable, therefore, to decrease the difficulty, rate of error and time consumption of using online billpay.

Further, because it is often difficult to input large amounts of information, and do so accurately, on a mobile device, it would be desirable to provide for a way to increase the efficiency of the online billpay process.

It would be desirable, therefore, to provide for extracting information from a paper statement. It would be further desirable to use that information to populate one or more billpay fields. It would be yet further desirable to save that information for future use.

Therefore, systems and methods for photograph billpay tagging are provided.

### SUMMARY OF THE INVENTION

Apparatus, methods, code and encoded media (individually or collectively, “the tool” or “the tools”) for photograph billpay tagging are provided.

The tool may receive a digital image. The digital image may correspond to a portion of text. The portion of text may be positioned upon a medium. The text may correspond to billpay information.

The tool may define a frame. The frame may be a reference frame. The reference frame may be a graphical reference frame for the digital image.

The tool may identify one or more glyphs. The glyphs may be a set of glyphs. The set of glyphs may be identified within the text.

A portion of the digital image within the reference frame may be translated. The image may be translated into a group of characters. The image may be translated via an electronic algorithm implemented by a processor. The translated portion of the digital image corresponding to at least a part of the set of glyphs.

The tool may tag the portion of the digital image. The digital image may be tagged with a tag. The tag may be coupled with a field. The field may be a billpay input field. The billpay input field may be populated. The billpay input field may be populated with the group of estimated characters. The bill input field may be populated based on the coupling.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows illustrative apparatus in accordance with the principles of the invention;

FIG. 2 shows illustrative information in accordance with the principles of the invention;

FIG. 3 shows other illustrative information in accordance with the principles of the invention;

FIG. 4 shows yet other illustrative information in accordance with the principles of the invention;

FIG. 5 shows still other illustrative information in accordance with the principles of the invention;

FIG. 6 shows yet other illustrative information in accordance with the principles of the invention;

FIG. 7 shows yet other illustrative information in accordance with the principles of the invention;

FIG. 8 shows yet other illustrative information in accordance with the principles of the invention;

FIG. 9 shows yet other illustrative information in accordance with the principles of the invention;

FIG. 10 shows yet other illustrative information in accordance with the principles of the invention;

FIG. 11 shows yet other illustrative information in accordance with the principles of the invention;

FIG. 12 shows yet other illustrative information in accordance with the principles of the invention;

FIG. 13 shows yet other illustrative information in accordance with the principles of the invention;

FIG. 14 shows yet other illustrative information in accordance with the principles of the invention; and

FIG. 15 shows other illustrative apparatus in accordance with the principles of the invention.

### DETAILED DESCRIPTION OF THE INVENTION

Apparatus, methods, code and encoded media (individually or collectively, the “tool” or “tools”) for image-capture billpay tagging, data extraction and/or billpay field populating in a complex machine information environment are provided. The complex machine information environment may be administered by a financial institution.

The encoded media may be articles of manufacture. The media may contain the code. The code may be embedded in the media. The code may be computer program code. The code may control, and/or otherwise direct activities of, the apparatus. The apparatus may perform the methods. The methods may be performed to execute image-capture billpay tagging. The image-capture billpay tagging may include photographic billpay tagging. The methods may be performed to execute data extraction. The methods may be performed to execute billpay field populating.

The tools may include a device, such as telephone, smartphone, tablet, phablet, laptop, desktop, watch, smartwatch, or any other suitable device. The device may be under the control of a user. The device may include an image-capture apparatus, such as a camera; scanner; optical, infrared and/or magnetic reader; or any other suitable image capture apparatus. Other suitable image capture apparatus may include an audio detector. Other suitable image capture apparatus may include an electromagnetic-pattern detector.

The device may capture an “image.” The image may represent an electromagnetically detectable pattern. The image may represent a visually detectable pattern. The image may represent an acoustically detectable pattern. The image may be captured as a digital image.

The device may include image processing capabilities. The image processing capabilities may be resident in the device. The image processing capabilities may be accessed by the device. The image processing capabilities may hosted by the financial institution.

The image processing capabilities may include barcode decoding. The image processing capabilities may include QR code decoding. The image processing capabilities may include optical character recognition (“OCR”) capabilities. The image processing capabilities may include any other suitable image processing capabilities. Other suitable image processing capabilities may include voice recognition capabilities. Other suitable image processing capabilities may include facial recognition capabilities. Other suitable image processing capabilities may include body-language recognition capabilities. Other suitable image processing capabilities may include eye-movement recognition capabilities. Other suitable image processing capabilities may include pupil-dilation recognition capabilities.

The tools may receive information. The digital image may include the information. The digital image may correspond to one or more of alphanumeric characters, symbols, marks, ciphers, icons, glyphs and any other suitable information. Other suitable information may include graphics. Other suitable information may include logos. Other suitable information may include sounds. Other suitable information may include gestures. Individually and collectively, any and all forms of suitable information may be referred to as “text.” All or a portion of the text may be machine generated. All or a portion of the text may be non-machine generated, such as by one or more humans. All or a portion of the text may be printed. All or a portion of the text may be handwritten.

The text may be included on, upon, about, in and/or within a medium. The text may be located on, upon, about, in and/or within the medium. The text may be positioned on, upon, about, in and/or within the medium. The text may be portrayed on, upon, about, in and/or within the medium. The text may be displayed on, upon, about, in and/or within the medium. The text may be stored on, upon, about, in and/or within the medium.

The medium may be paper. The medium may be a screen. The screen may be an electronic screen. The medium may be any other suitable medium from which the device may capture an image of the text. Any other suitable medium may include a chemical emulsion containing text. Any other suitable medium may include a region of air vibrating with an acoustic pattern. Any other suitable medium may include a region of space hosting a holographic projection. Any other suitable medium may include a human face.

The text may correspond to the information. The information may include billpay information. The billpay information may be any suitable information related to billpay activities. The suitable information may include payor identification. The suitable information may include payee identification. Payee identification may include payee nomination. Payee identification may include a company logo. Payee identification may include a company sound-pattern, such as a jingle or phrase. The suitable information may include payee location. Payee location may include a website. The website may include an operational link to the website. The suitable information may include a payment amount. The suitable information may include a late-payment assessment amount. The suitable information may include terms of payment.

The text of the suitable information may be included on, upon, about, in and/or within a paper payment-due bill, a paystub, a financial instrument and/or any other suitable vehicle portraying the information. Other suitable vehicles may include a digital representation of a payment-due bill. Other suitable vehicles may include a telephonic request for payment. Other suitable vehicles may include an oral statement of contractual agreement.

The tools may translate a portion of the image representing a section of the text that corresponds to billpay information into a group of estimated characters. The portion of the image may be within the reference frame. Any portion of the image not within the reference frame may not be translated. The estimated characters may include symbols. The estimated characters may include alphanumeric characters. The estimated characters may include graphics. The estimated characters may include operational website links.

The tools may populate billpay fields with one or more members of the group of estimated characters. The tools may provide the user capabilities of reviewing the estimated characters populating one or more billpay fields. The tools may provide the user capabilities of correcting the estimated characters populating one or more billpay fields.

Estimated characters may require correction. The user may provide the correction.

The image may include one or more segments corresponding to indecipherable text. The indecipherable text may include one or more components that are unrecognizable, illegible, unreadable, incomprehensible, indecipherable or otherwise unclear. The one or more components may be decipherable to the user.

The image may be processed to identify one or more lines, columns, paragraphs, captions, symbols or tables. The processing may isolate one or more characters.

The one or more components may be indecipherable on, upon, about, in and/or within the medium, with image-capture producing a high fidelity image of the component(s). Alternatively and/or additionally, the component(s) may be decipherable on, upon, about, in and/or within the medium, but, as represented in the image, may be indecipherable. Alternatively and/or additionally, the component(s) may be decipherable on, upon, about, in and/or within the medium, with image-capture producing a high fidelity image of the component(s), but image processing may poorly estimate the component(s).

Image-capture and/or image processing may degrade decipherability of the imaged text. Decipherability of the imaged text may be enhanced by running algorithms for de-skewing, despeckling, binarization, normalization and/or any other suitable processing. Other suitable image-enhancing processing may include character isolation. Other suitable image-enhancing processing may include layout detection.

Upon capturing the image, the tools may implement one or more image-enhancing processes. For example, the tools may implement a de-skewing algorithm if the image, when captured, was not properly aligned with the reference frame. Degradation of decipherability of the imaged text may result in indecipherability of the imaged text. Image-enhancing processes may compensate, in whole or in part, for the degradation.

The tools may produce one or more alternative sets of one or more members of the group of estimated characters with which to populate a given billpay field. The tools may select from the one or more sets a default set with which to populate the billpay field. The tools may provide the user capabilities of selecting the set with which to populate the billpay field.

Illustrative processes that may be followed in the user's utilization of the tools may include selection of the text. The user may select the text corresponding to billpay information. The user selection of the text may be an automated process, automated in whole or in part, executing pre-standing instructions of the user. The automated process may routinely survey the user's electronic mail, conventional mail and/or business dealing for a billpay information-bearing text.

The tools may define a frame for the text. The frame may serve as a reference frame. The reference frame may include a graphical reference frame. The graphical reference frame may include a graphical coordinate system. The graphical coordinate system may be electronically overlain on images captured. The graphical coordinate system may specify a set of unique coordinates for each location within the image within the frame.

The tool may define the frame for processing. The frame may be defined by delineating one or more boundaries of the medium. The one or more boundaries may be visually, optically, acoustically, spatially, temporally and/or digitally delineated. For example, the tools may define image-capture boundaries for the medium. The tools may instruct the user to position the device relative to the medium so as to maximize the scope and fidelity of image-capture of the text. The device may capture an image of the text within the boundaries within the reference frame.

The text of the medium may include one or more glyphs (or other marks). The user may select the one or more glyphs (or other marks) within the text. The tools may identify in the image representations of the one or more glyphs. The representations in the image of the one or more glyphs may be located at specific locations within the image. The tools may correspond the specific locations with specific coordinate sets of the reference frame.

The glyph may be recognized visually by the user and/or electronically, through capture and preliminary processing of the image, as a candidate for being a company logo. The image of the logo may be further processed to verify the identification of the company as a candidate payee. The logo may be compared with logos of companies to which the user has made one or more payments. The logo may be compared with all logos known to the financial institution. If the logo remains unknown, unverified or otherwise unrecognizable, the tools may prompt the user (1) to verify the candidacy of the glyph as a logo and/or (2) to identify the logo as that of a given payee company. Based on the response of the user, information about the logo may be added to a central database, from which it may be retrieved for subsequent identification of logos and/or of payee companies via their logos.

Two or more glyphs may be defined as a set of glyphs based on proximity of the glyphs in the text and/or on proximity of their images within the reference frame. The glyphs may be defined as a set based on their being located within a defined region of the medium and/or their images being located within a defined region of the reference frame. The region may be defined by its inclusion of a labeled feature of the text or the image, such as an area on a payment-due bill labelled “PAY THIS AMOUNT.”

The text of the medium may include one or more glyphs or sets of glyphs that may correspond to other billpay information, such as payor identification and payment amount. Image-capture and image processing of those glyphs may provide for machine-populating of billpay fields with estimated characters corresponding to the billpay information.

Image processing may include the tools translating the image. One or more processes may be used to translate the image. The image may be translated using an algorithm. The algorithm may be an electronic algorithm. The algorithm may be implemented by an electronic processor.

The image may be translated into a character. The image may be translated into a group of characters. The group of characters may be a group of estimated characters. The group of estimated characters may be characters that have been translated using OCR. The group of estimated characters may be a group of unverified and/or unconfirmed characters.

For example, OCR may be used to translate the image. The image may be translated into a group of characters. The OCR may provide an estimated translation of the image. The estimated translation may include the estimated group of characters. The estimated translation may be verified immediately. The estimated translation may be verified at a later point.

Verification of the translation may include any suitable processes for reducing rates of error for OCR. For example, the verification may adjust the algorithm. The verification may execute a second OCR process on the same image.

The verification may determine if there are differences between the results of a first OCR process and a second OCR process executed on the same image. For example, the first OCR process may translate the image into a first group of estimated characters and the second OCR process may translate the image into a second group of estimated characters. The tools may determine differences between the first group and the second group.

The differences between the first group and the second group may be computed by comparing an estimated group of characters of the first group to an estimated group of characters of the second group, with quantification of the comparison. For example, the tools may compute the number of characters in the first group. The tools may compute the number of characters in the second group. The tools may compute the number of characters that are identical, similar but not identical, and/or different between the two groups. The tools may calculate an index of difference.

For example, the first group and the second group may each include two hundred characters, with twenty characters in the first group and twenty characters in the second group differing. The index of difference may be calculated by adding the twenty characters from each group (40) and calculating that as a percentage of the total. Thus, the percentage difference may be 40/400=10% difference rate.

The verification may include a threshold percentage. The threshold percentage may be a maximum percentage of allowed difference. The threshold percentage may be a minimum percentage of required conformance between the groups of characters.

The estimated characters may be alphanumeric characters. The characters may be recognizable, decipherable, readable, legible, intelligible and/or otherwise comprehensible in computer-readable code and/or in computer-readable font.

The translation may compare the image to data in one or more data-sets. A datum in the one or more data-sets may include an electronic record. The electronic record may include an electronic representation of a glyph. For example, the tools may include a database. The database may be stored on computer-readable media. The database may be stored in computer-readable memory. The database may include glyph data, symbol data, logo data, character data and any other suitable data. Other suitable data may include locations of companies. Other suitable data may include the user's purchasing history from a given company.

The database may store one or more templates of text features. The templates may be a data set. The templates may include templates of glyphs. There may be multiple templates stored for a given glyph. For example, the database may store one or more templates of the numeral “3.” As another example, the database may store one or more templates of the character “&.” Different templates for a given text feature may be created and stored based on different fonts shapes, font sizes, languages, alphabets, handwriting, or any other suitable distinguishing features. Other suitable distinguishing features may include font color. Other suitable distinguishing features may include glyph-background color. The templates may be stored in computer-readable memory.

A glyph within the text (“text glyph”) or its representation within the image (“image glyph”) may be compared to one or more templates of possible glyphs. A text glyph or its corresponding image glyph may be compared to one or more stored representations of glyphs (“database glyphs”). Image glyphs may be matched to database glyphs. The matching may be executed by comparing a given image glyph with one or more possible database glyphs. The matching may involve pattern recognition. The matching may quantify the degree of similarity between the image glyph and the possible database glyphs. The matching may pair the image glyph with the database glyph that has the highest quantified measure of similarity. The matching may submit the database glyphs as a translation of the image glyph. The translation may become a candidate estimated character of the text glyph.

The digital image may be tagged. The digital image may be stored in computer-readable memory. The digital image may be saved in computer-readable memory. The image may be saved as a pre-processed indecipherable image and/or a post-processed decipherable image.

The pre-processed and/or post-processed digital image may be tagged. The image may be tagged with a tag. The tag may be an electronic identifier. For example, the tag may be an electronic link.

The tool may tag a portion of the digital image. For example, the tool may tag a location about the image. In a further example, the tool may tag one glyph in the upper left corner of the image. In yet a further example, the tool may tag a group of glyphs.

The tag may be a mark, digital mark, digital tag or label. The image may be tagged using an image capture apparatus.

The image may be tagged with multiple tags tags. For example, the image capture apparatus may tag a location upon a bill. The location may the location of one or more characters, identifiers or fields. In a further example, the image capture apparatus may tag the location of the “Payee Name” field upon the image. The location of the field may be a probable location. The location of the field may be a verified location.

An exemplary process using the tool is provided. A user may select a bill. The bill may be a paper bill. The paper bill may contain billpay information. The billpay information may include one or more non-computer recognizable glyphs. The user may capture a digital image of the bill.

The user may extract data from the bill. The data may be extracted from the digital image. The data or image may be translated into computer-readable text.

The computer-readable translated text may cause the processor to tag the bill. The bill may be tagged at a location. The location of the tag may be selected as a result of the translated billpay information. For example, the tag corresponding to “payee name” may be tagged to the location of the payee name upon the bill. In a further example, the bill may only be tagged at that location once the “payee name” has been translated and/or verified. In yet a further example, the translation of characters may cause the processor to recognize the field associated with the characters. In yet a further example, upon translating the characters from a location upon the bill, the tools may identify the characters as a prior payee of the customer. Based on the identification, the characters may be tagged with a payee tag.

The computer-readable text may be displayed to the user. The text may be displayed as an overlay on top of the image. The text may be displayed in the place of corresponding non-computer readable text from which it was processed.

The user may tag the bill prior to translation of the image. For example, the user may tag a location on the bill. In a further example, the user may identify the tagged location as “Payment Amount.” As a result, the processor may identify the tag as a “payment amount” tag. The identity of the tag and/or the location may be saved in computer-readable memory for later use. For example, after translation of the image, the tools may populate the translated from the “payment amount” location, based on the “payment amount” tag, into a billpay field.

The user may tag the bill after the translation of the image. For example, after the text within the image is translated into computer-readable characters, the user may tag a location upon the image. The user may tag the location of the characters upon the image.

An exemplary process for the tools is provided. For example, the tool may process the digital image. The tool may translate glyphs located upon the image into an estimated group of characters. The tool may then tag the estimated group of characters. The group of characters may be verified. The group of characters may not be verified. The group of characters may be verified after being tagged.

The group of characters may be tagged based on their location upon the image. For example, the tool may use an algorithm to determine one or more probable locations of text corresponding to a specified billpay field. The tool may search for a specified billpay field. For example, the tool may desire to locate the address. The tool may retrieve information that identifies one or more probable locations of the payee address upon a bill.

The probable locations may be based on recognizing one or more characteristics of a specified payee. For example, the tool may receive information via previously recognized characters, text, symbols, logo, instructions and/or pattern recognition. The information may be the identification of the payee. Based on the identification of the payee, the tool may estimate one or more probable locations of the payee address upon a bill. The tool may then tag one or more of the probable locations with the “payee address” tag.

In an embodiment, the group of characters may be tagged. The group of characters may be tagged prior to verifying the group of characters. The tag may be an unspecified and/or unspecialized tag. For example, the tool may identify the group of characters as including billpay information. However, the tool may be unable to identify the type of billpay information. The tool may tag the group of characters with a generic tag. The group of characters may then be verified and/or processed to determine the type of billpay information. The tag may be reconfigured as a specified tag for specified billpay information.

It should be noted that tagging of an image may be implemented using character and/or pattern recognition. The tags may be digital tags. The tags may be stored in computer-readable memory, and may be tagged and/or selection by the processor.

The selection of a location for tagging may be made by processing one or more previous images or bills. The processor may use known heuristic processes, such as numerical heuristics, pattern recognition and/or machine learning. The processor may identify one or more prior images of the user. The processor may identify one or more errors in translation of the glyphs and/or the correction of the errors. Based on the errors and/or corrections, the processor may adjust the translation of the image.

The processor may identify one or more locations in previous images submitted by the user. The processor may identify prior images and may identify one or more similarities between the prior images and the current image. For example, the processor may identify images with identical and/or similar glyphs. The processor may retrieve the verified group of characters for the glyphs in the prior image. The processor may then use the verified group of glyphs to parse and/or understand the current image. For example, based on an identified payee address in a prior bill for the same payee, the processor may tag the same location and position upon the current image.

For example, the processor may recognize the payee name field, or any other suitable field. The processor may search for patterns associated with that payee. For example, the processor may identify the location of the payment amount field on all images and/or bills from that identified payee. The tools may tag that same corresponding location on the present bill.

The tag may be coupled with a datum. The tag may be a first tag. The datum may include and/or be associated with the first tag. The datum may include and/or be associated with a second tag. The datum tag may be complementary to the first tag. The first tag and/or second tag may be coupled with an identifier. The datum tag may be coupled with a second electronic identifier. The second electronic identifier may be a second electronic link.

The datum may be a data field. The data field may be an input field. The input field may receive data. The input field may be a billpay input field. The billpay input field may receive billpay data. The billpay input field may be coupled with the tag.

The coupling of the billpay input field with the tag may cause the processor to transmit an instruction. The instruction may be an instruction to retrieve billpay information. In order to retrieve the billpay information, the processor may retrieve the tag coupled with the billpay field. The processor may then retrieve the digital image for the tag. The tools may pinpoint the location of the tag about the digital image.

The glyphs associated with the tag and/or location of the tag upon the digital image may correspond to a billpay input field. For example, the image tag may correspond to the tag for the billpay input field. In a further example, the image tag ands the billpay input field may both include an identifier for “payee name.” The glyphs associated with the location of the tag may populate the billpay field.

The processor may retrieve the group of characters corresponding to the glyphs associated with the tagged location. The group of characters may populate the billpay input field.

The group of characters may be copied and/or selected. The group of characters may be pasted into a billpay field. The group of characters may populate a billpay field.

The billpay field may be any suitable data field. The data field may receive billpay information. Exemplary data fields may include, but are not limited to payee name, payee address, payor name, payor address, payment amount, amount, payment date, due date, amount paid, payment type or any other suitable information.

The billpay input field may be populated. The populating of the billpay input field may be displayed. The populating of the billpay input field may cause the processor to display the populated billpay input field on a graphical user interface (“GUI”). The GUI may be displayed to a user.

The digital image may include one or more portions. The one or more portions may be portions of the digital image. The digital image may include a first portion. The digital image may include a second portion.

The group of characters may be an estimated group of characters. The estimated group of characters may be a first estimated group of characters. The group of characters may be a second estimated group of characters. The group of characters may be a first verified group of characters. The group of characters may be a second verified group of characters.

The billpay input field may be one of a plurality of input fields. The billpay input field may be a first billpay input field. The billpay input field may be a second billpay input field.

The tool may translate a first portion of the digital image. The first portion may be translated into a first group of characters. The tool may translate a second portion of the digital image. The second portion may be translated a second group of characters. The second group of characters may be a second estimated group of characters.

The first portion of the digital image may be tagged. The tag may be a first tag. The second portion of the digital image may be tagged. The tag may be a second tag.

The second tag may be coupled with a billpay input field. The billpay input field may be a second billpay input field. The coupling of the second tag with the second billpay input field may cause the second billpay input field to be populated. The field may be populated a group of characters. The group of characters may be the second estimated group of characters. The group of characters may be the second verified group of characters.

Exemplary tools for tagging an image, field, text, glyph and character are provided. The tagging may include selecting a glyph. The glyph may be a set of glyphs. The set of glyphs may be located within text. The selected glyphs may correspond to a portion of the digital image. The selected glyphs may correspond to a segment of the portion of the digital image.

The segment may be electronically marked or highlighted. The segment of the portion of the digital image may be electronically marked or highlighted.

The highlighting may be displayed to a user on a user interface. The display may be a GUI. The highlighting may be displayed using any suitable visual indicator, such as color, size or font.

The highlighted segment may correspond to a character. The highlighted segment may correspond to a group of characters. The group of characters may be an estimated group of characters. The group of characters may be a verified group of characters. The highlighted segment may correspond to at least a portion of the group of characters.

The tool may establish a link. The link may be an electronic link. The electronic link may an identifier, pairing, URL or any other suitable link.

The link may be established between the highlighted segment of the image and the portion of the group of estimated characters. The link may correspond to the tag. The tag may be a link.

The link may be a first link. The first link may be a first electronic link. The link may be a second link. The second link may be a second electronic link.

The coupling of the tag with the billpay input field may establish a link. The coupling of the tag with the billpay input field may result from an established link.

The coupling may include establishing an electronic link between a tagged segment and a billpay input field. The coupling may include establishing an electronic link between a tag and a billpay input field. The tag may already be associated and/or tagging an image. The tag may not yet be associated with and/or tagging an image.

If the tag is not yet associated with an image, an electronic link may be established between the tag and the coupled billpay input field. When the tag is subsequently tagged to an image, the tagged segment may also, and/or as a result of the tagging, be electronically linked to the billpay input field.

If a billpay input field is already coupled to a tag, and the tag has already been tagged to an image, the electronic link may be established based on the coupling of the billpay input field with the tag.

The first electronic link may be a link between the tag of a tagged segment and a billpay input field. The second electronic link may be a link between the tagged segment and the billpay input field. The second electronic link may link the characters of the segment with the billpay input field.

The first electronic link and the second electronic link may be connected, associated and/or linked. For example, the first electronic link may be a link between a tag and a group of characters. The second electronic link may be a link between the tag and a billpay input field.

This may optionally form a third electronic link. The third electronic link may directly link the group of characters from the tagged segment with the billpay input field. The billpay input field may be populated. The billpay input field may be populated with the portion of the group of estimated characters.

The billpay input field may be determined based on the estimated group of characters. For example, based on certain recognized features of the estimated group of characters, the proper billpay input field for the estimated group of characters may be determined. In a further example, the tool may recognize the symbol “$” in the estimated group of characters. The tool may then determine that the proper billpay input field is “Amount Due.”

The first billpay input field may correspond to an error. For example, the first billpay input field may be selected in error. In a further example, based on recognizing the symbol “$” the tool may improperly the determine the billpay input field as “Amount due.” In yet a further example, the proper billpay input field for the text associated with the “$” symbol may be “current balance.” “Current balance” may be a different monetary amount.

Based on the error in the selection of the billpay input field, a second billpay input field may be received and/or selected. The second billpay input field may be selected to correct the error. The second billpay input field may be selected by the processor upon realization and/or notification of an error. The second billpay input field may be selected based on a probable selection of the proper billpay input field for the estimated group of characters.

The tag coupled to the first billpay input field may be uncoupled, de-coupled, and/or otherwise unlinked from the first billpay input field. The de-coupling of the tag from the first billpay input field may remove, or cause the processor to remove, the estimated group of characters from the first billpay input field.

The tag may be coupled to a second billpay input field. The tag may be linked to the second billpay input field. The tag may be immediately coupled to the second billpay input field upon de-coupling from the first billpay input field. Based on the coupling of the tag to the second billpay input field, the estimated group of characters may be associated and/or linked with the tag.

The coupling of the tag to the second billpay input field may cause the processor to insert the estimated group of characters into a billpay input field. the estimated group of characters may be the group of characters associated with the tag. The estimated group of characters may be inserted in the second billpay input based on the coupling of the tag to the second billpay input field.

The user may input a correction. The tool may receive a correction. The correction may be a user correction. The correction may a correction from the tool itself. The tool may correct itself using any suitable internal controls or quality control mechanisms.

The correction may be a correction of the billpay input field. The correction may a correction of the selection of a billpay input field. The correction of the selection may be based on the improper selection of the first billpay input field. The correction may be completed by selecting a second billpay input field.

The user may submit a correction of the billpay input field. The user may submit a correction of the estimated group of characters. For example, the user may note that the improper billpay input field was selected for an estimated group of characters.

In a further example, the user may have previously requested the selection, by the tool, of the proper billpay input field for a selection of characters. The selection of the billpay input field may have been incorrect. The user may then identify the proper billpay input field. The correction to the billpay input field may stored in computer-readable memory.

In yet a further example, the user may submit a correction of the estimated group of characters. The user may select a billpay input field. The user may request that the tool retrieve the appropriate estimated group of characters, from an image, for the selected billpay input field. The tool may retrieve the improper group of characters. The user may submit a correction. The correction may be a user selection of the proper group of characters from the image. Based on the correction, the group of estimated characters may be adjusted. The corrections and/or adjustments may be stored in computer-readable memory.

The estimated group of characters may be tagged. The group may be tagged with a tag. The tag may couple one or more groups. The tag may couple one or more fields. The fields may be data fields.

The tag may be coupled to a field. The field may be a billpay field. The billpay field may be a billpay input field. The tag may be coupled with the billpay input field.

The tag may be used as an identifier. The tag may signal or induce the occurrence of one or more actions.

The coupling of the tag to the input field may cause the population of the input field. The coupling of the tag to the input field may be used as an indicator to instruct the tool to populate the input field. For example, the processor may recognize that the input field has been tagged. Based on the coupling of the tag to the input field, the processor may identify the tag.

In a further example, the processor may then retrieve data associated with the tag. The data associated with the tag may include the estimated group of characters. The tag may be used to identify the estimated group of characters.

Based on the coupling of the tag to the billpay input field, the billpay input field may be populated. The billpay input field may be populated with one or more characters. The billpay input field may be populated with an estimated group of characters. The estimated group of characters may be associated with, or coupled to, the tag.

The tag may be one of a plurality of tags. The tag may be a first tag. The billpay input field may be one of a plurality of fields. The billpay input field may be one of a plurality of billpay input fields. The billpay input field may be a first billpay input field. The first tag may be coupled to the first billpay input field.

The second tag may be coupled with the second billpay input field. Based on the coupling of the second tag with the second billpay input field, the second billpay input field may be populated. The second billpay input field may be populated with a group of characters. The group of characters may be associated with the second tag coupled with the second billpay input field. The second billpay input field may be populated with the second estimated group of characters.

The tagging may include selection of a character within an image or text. One or more characters within the text may be selected. A portion of the text may be selected. A portion of characters within the text may be selected.

The selected portion may be highlighted. The characters may be highlighted. The highlighted characters may correspond to a group of characters. The highlighted characters may correspond to an estimated group of characters. The characters may be highlighted to identify the estimated group of characters.

The highlighting of the group of characters may identify characters in a specific location. For example, the characters highlighted may correspond to one or more characters that represent billpay information. In a further example, the characters representing the “payee address” may be highlighted.

The highlighting may correspond to a selection by the processor. The selection may be based on an algorithm. The processor may use the algorithm to identify characters for a specified billpay field. For example, the algorithm may attempt to search for indicators on a paystub. In a further example, the algorithm may search for address fields. The algorithm may be programmed to identify probable locations, on the paystub, of addresses. In a further example, the algorithm may identify a portion of text including a two letter identifier (representing a state) and a five digit number (representing a zip-code) in the lower right portion of the paystub as likely corresponding to the payee address. The algorithm may attempt to confirm this using a confirmation sequence. The confirmation sequence may include verifying the address and/or zip-code as a known location of a payee associated with an account.

The highlighted characters may be characters suitable for populating a billpay field. For example, a user may highlight a selection of characters on an electronic image of the paystub. The user may instruct the processor to duplicate the characters from the paystub. The duplicated characters may be populated into a billpay input field. For example, the user may identify “payee name” on the paystub. The user may highlight the information corresponding to “payee name” on the paystub. The highlighted information may be inserted into the billpay field for the payee name.

In another example, the user may capture an image of a bill. The bill may contain non-computer readable, or non-computer recognizable characters. For example, the image may contain characters unidentifiable to the processor. The user may select a portion of the bill. For example, the user may select “$342.67” for “amount due,” stated on the bill.

The processor may determine the designated input field for the highlighted text. For example, based on the presence of the “$” symbol, the processor may determine that this amount should populate the input field of “amount due” for the billpay information. In another example, the presence of numbers and a decimal point may cause the processor to determine that this amount should populate the input field corresponding to “amount due.”

The billpay input field may be designated. The input field may be designated for a portion of characters. The designation may be a designation to receive the portion of characters. The designation may be a designation identifying the billpay input field as the proper input field for a specified type of characters.

The designated billpay input field for a group of characters may be determined based on a tag. The tag may be coupled with the billpay input field. For example, a group of characters may be tagged with a tag. The tag may then be coupled to a billpay input field. The tag may be previously coupled with a specified billpay input field. The tag may be subsequently coupled with a specified billpay input field.

For example, a tag may be identified as a “payor address” tag. The tag may be coupled with the “payor address” billpay input field. The apparatus and methods may be configured to tag a portion of the paystub. The portion of the paystub may be the location of an identified “payor address” upon the paystub. The portion of the paystub may be the location of a possibly identified or estimated “payor address” upon the paystub.

In a further example, the apparatus and methods may extract the characters corresponding to the “payor address” from upon the paystub. The processor may determine if the tag is coupled to one or more fields. For example, the processor may determine that the tag is coupled with a billpay input field. In a further example, the tag may be coupled with the “payor address” billpay input field. The billpay input field may be populated with the characters associated and/or tagged with the tag. The characters associated with the tag may be the highlighted characters.

The billpay input field may be a first billpay input field. The first billpay input field may correspond to any suitable billpay input field. For example, the first billpay input field may correspond to “amount due.”

The billpay input field may be a second billpay input field. The second billpay input field may correspond to any suitable billpay input field. For example, the second billpay input field may correspond to “due date.”

The apparatus may populate the first billpay input field. The first billpay input field may be populated based on a first tag. The first billpay input field may be populated based on a coupling of the first billpay input field with the first tag. The first tag may be associated with a first group of characters. Based on the first tag, the first group of characters may be filled into the first billpay input field.

A user may select the second billpay input field. The second billpay input field may be selected as a result of an error. For example, the first tag may properly correspond to the first billpay input field. In a further example, both the first and the first billpay input field may be associated with “account number.” In yet a further example, the first tag may be improperly used to tag the first group of characters. In yet a further example, the first group of characters may correspond to information for “payor address.”

The user may select the second billpay input field to correct an error. For example, the second billpay input field may correspond to the input field for “payor address.” The user may attempt to de-populate the estimated group of characters from the first billpay input field.

In a first embodiment, the first billpay input field may be improperly coupled with a tag. For example, the first billpay field may be configured to receive “payment date” input. The first tag coupled to the first billpay input field may be a “payor name” tag. The estimated group of characters may include information corresponding to the payor name. The estimated group of characters may be tagged with the first tag. The first tag may erroneously be coupled with the first billpay input field. Based on the coupling, the first billpay input field may be populated with the estimated group of characters.

In a second embodiment, the group of characters may be improperly tagged. For example, the group of characters may include information corresponding to “services rendered.” The group of characters may be tagged with a first tag. The first tag may correspond to a tag for data associated with “payee address.” The first tag may be coupled with the first billpay input field. The first billpay input field may be configured to receive characters from the bill associated with “payee address.”

The user may instruct the processor to de-couple the first tag from the first billpay input field. The processor may recognize the error without user instruction. For example, the processor may process information from past occurrences or pattern recognition. The processor may utilize that information to diagnose an error. The processor may de-couple the first from the first billpay input field.

The first tag may be coupled with the second billpay input field. For example, the first tag, corresponding to information for “payee address,” may be coupled with the second billpay input field. In a further example, the second billpay input field may be configured to receive information for “payee address.”

Based on the de-coupling of the first tag from the first billpay input field, the processor may remove the estimated group of characters from the first billpay input field. Based on the coupling of the first tag with the second billpay input field, the processor may populate the second billpay input field with the estimated group of characters.

The processor may untag the estimated group of characters. This may occur as a result of the processor recognizing a tagging error. For example, the estimated group of characters may be tagged with a first tag. The first tag may be associated with “minimum amount due.” The data in the estimated group of characters may be “payment date” data. The processor may tag the estimated group of characters with a second tag. The second tag may be associated with “payment date” data. The second tag may be associated with a billpay input field. The billpay input field may be populated with the estimated group of characters.

The user may input a correction. The correction may correspond to a selection. The selection may be a selection, by the processor of a billpay input field. The selection may occur based on the tagging of characters. The characters may be improperly tagged. Based on the improper tagging, the improper billpay input field may be populated. The user may select a second billpay input field.

The user may transmit an instruction. The instruction may be an instruction to re-designate one or more of the tags. The instruction may be an instruction to re-tag one or more characters. The instruction may be an instruction de-couple and/or re-couple the tag with one or more billpay input fields.

The apparatus may include and the methods may provide for calculating a confidence level. The confidence level may be calculated at the time the image is captured. For example, a confidence level may be calculated for the accuracy of the image captured. A confidence level may be calculated for one or more tags. For example, a confidence level may be calculated based on a perceived accuracy of a tagging. The accuracy of a tagging may include the accuracy of the tagging of the characters with the first tag.

The accuracy may be calculated using any suitable factors, such as past occurrences, algorithms, machine learning, optical character recognition, confidence levels of optical character recognition and any other suitable factor.

In one embodiment, the invention may be preferably operated at a certain confidence level. The confidence level may be required to input billpay information from an image. For example, a threshold confidence level may be required to input billpay information. The confidence level may be any suitable level, such as a percentage of confidence.

In a second embodiment, an electronic image of a medium is captured only upon exceeding the threshold confidence level. The image may be translated. The image may be processed. The processing and/or translating may include character recognition. The character recognition may include optical character recognition. The processing and/or translating may be enhanced using an electronic algorithm. The electronic algorithm may be implemented by a processor.

The processor may translate a portion of the billpay information located upon the medium. For example, the processor may process the billpay information and translate it into one more computer-recognizable billpay characters.

The computer-recognizable billpay characters may be extracted from the billpay information. The billpay characters may be tagged with a tag. The tag may be coupled with a billpay input field. The billpay input field may be populated with the billpay characters.

A measure of correspondence may be calculated. The measure of correspondence may be a first measure of correspondence. The measure of correspondence may be a second measure of correspondence. The measure of correspondence may compute the correspondence of a group of processed characters. The group of translated characters may be compared to a group of un-processed and/or computer-unrecognizable characters. The comparison may determine correspondence levels between the two groups. The correspondence level may be computed in any suitable manner, such as a percentage correspondence. The correspondence level may be calculated using confidence levels, character recognition, or difference calculations. Difference calculations may determine perceived differences and/or variations between the first group and the second group.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage encoded media having computer-readable program code, or instructions, embodied in or on the storage encoded media. Any suitable computer readable storage encoded media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting encoded media such as metal wires, optical fibers, and/or wireless transmission encoded media (e.g., air and/or space).

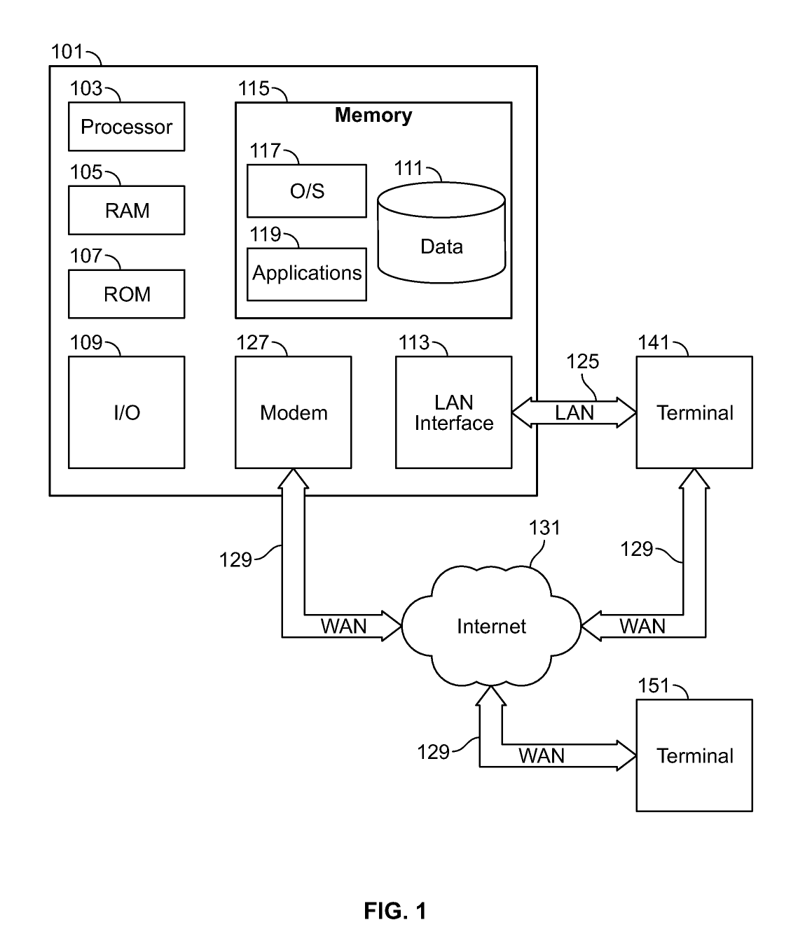

Processes in accordance with the principles of the invention may include one or more features of the information illustrated in FIGS. 1-15. For the sake of illustration, the steps of the processes illustrated in FIGS. 1-15 may be described as being performed by a “system.” The “system” may include one or more of the features of the apparatus that are shown or described herein and/or any other suitable device or approach. The “system” may be provided by an entity. The entity may be an individual, an entity or any other suitable entity.

Illustrative information that is exchanged with the system may be transmitted and displayed using any suitable markup language under any suitable protocol, such as those based on JAVA, COCOA, XML or any other suitable and languages or protocols.

FIG. 1 shows illustrative schematic 100. Schematic 100 may be a system.

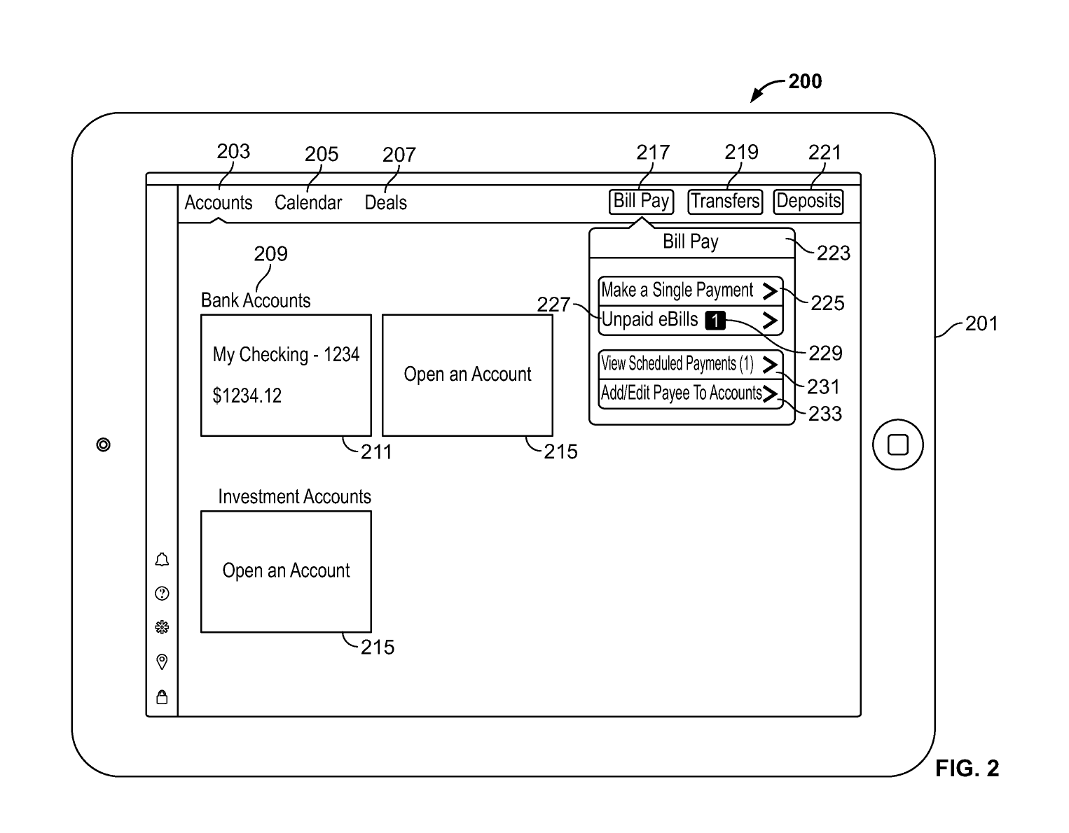

System 100 may share one or more features with the information shown in FIGS. 2-15. System 100 illustrates a computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output (“I/O”) module 109, and memory 115.

I/O module 109 may include a microphone, keypad, touch screen and/or stylus through which a user of a device may provide input, and may also include one or more of a speaker for providing audio output and a video display device for providing textual, audiovisual and/or graphical output. Software may be stored within memory 115 and/or other storage (not shown) to provide instructions to processor 103 for enabling server 101 to perform various functions. For example, memory 115 may store software used by server 101, such as an operating system 117, application programs 119, and an associated database 111. Alternatively, some or all of server 101 computer executable instructions may be embodied in hardware or firmware (not shown).

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131.

It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown). Terminal 151 and/or terminal 141 may be portable devices such as a laptop, tablet, smartphone or any other suitable device for storing, transmitting and/or transporting relevant information.

Any information described above in connection with database 111, and any other suitable information, may be stored in memory 115. One or more of applications 119 may include one or more algorithms that may be used for photograph billpay tagging and/or any other suitable tasks.

FIG. 2 may include display 200. Display 200 may be displayed on a graphical user interface (“GUI”). The GUI and/or display 200 may be displayed on any suitable device, such as mobile device 201.

Display 200 may display account information. The account information may be bank account information. The account information may be any suitable account information. The account information may include information for online billpay.

Account information may include accounts 203, calendar 205 and deals 207. Account 203 may be a tab within account information. Account 203 may contain information corresponding to one or more accounts, such as bank accounts 209 and investment accounts 215.

Bank accounts 209 may include any suitable information. For example bank account 209 may include information for one or more bank accounts.

Bank accounts 209 may include account information 211. Information 211 may be information for a specific account, such as a checking, savings, money market, credit card, credit line, loan or any other suitable account.

Bank accounts 209 may include open account tab 215. Account tab 215 may be clickable. When clicked, account tab 215 may allow a customer open an account.

Display 200 may include billpay tab 217. Billpay tab 217 may be a clickable tab. When clicked, billpay tab 217 may open another screen. Billpay tab 217 may display information when rolled over. The information may be billpay information 223.

Information 223 may include any suitable billpay information. Information 223 may include one or more billpay options. For example, information 223 may offer a customer an option to make a single bill payment by clicking on tab 225.

Information 223 may include unpaid ebills 227. Unpaid ebills 227 may include identifier 229. Identifier 229 may identify a number. The number may be the number of unpaid ebills. When clicked, ebills 227 may direct the customer to another screen.

Information 223 may include schedule payments tab 231 and add/edit pay to account tab 233. Tab 231 may be clickable. When clicked, scheduled billpay payments may be displayed.

Tab 233 may be clickable. When clicked, the customer may be presented with one or more options. The options may include add or edit payee to accounts.

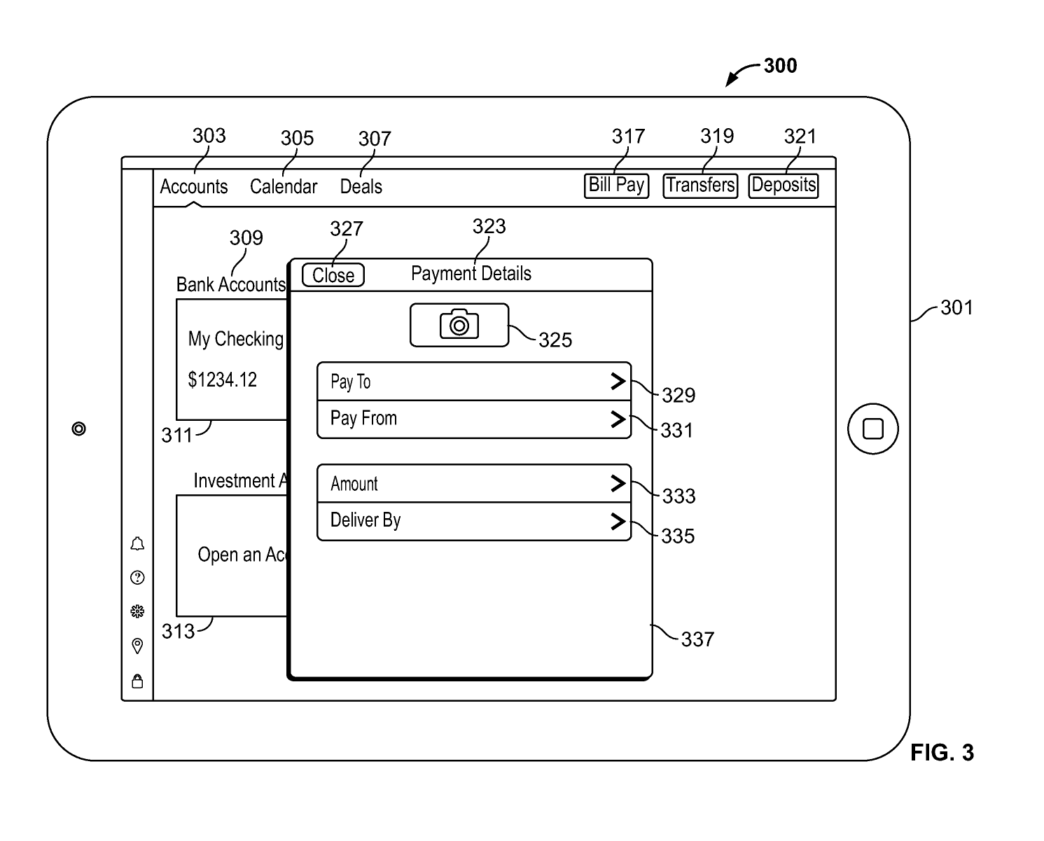

FIG. 3 may include display 300. Display 300 may be a GUI. Display 300 may be displayed using mobile device 301. Mobile device 301 may include some or all of the features of mobile device 201.

Display 300 may include tabs 303, 305, 307, 309, 311, 313, 317, 319 and 321, which may include some or all of the features of tabs 203, 205, 207, 209, 211, 213, 217, 219 and 221, respectively.

Display 300 may include payment details 323. Payment details 323 may be a display screen 337 overlayed on top of display 300.

Details 323 may provide an option for performing one or more billpay actions. For example, details 323 may allow a user to transmit payment using online billpay. The payment may be a bill payment. The bill payment may be a bill for an account. The account may be an account with the financial institution. The account may an account with a third party. The third party account may be paid using any suitable using the financial institution's online billpay program.

Details 323 may include one more fields. For example, details 323 may include fields 329, 331, 333 and 335.

Field 329 may display a name or identifier. The name may be a payee name. The name may be the name of the payee for payment using online billpay.

Field 331 may display a name or identifier. The name may be a payor name. The name may be the name of the payor submitting payment using online billpay. The name may be an alias of the payor. The name may the name of a third party. The payor may be submitting payment on behalf of the third party.

Field 333 may display an amount. The amount may be an amount due. The amount may a payment amount. The amount may be a payment amount selected by the payor.

Field 335 may display a date. The date may be any suitable date, such as a payment date or due date. The date may be selected by the payor. The date may be the due date selected by the account holder.

Details 323 may include image capture option 325. Image capture 325 may be selectable by a user. Image capture 325, when selected, may utilize an image capture apparatus. Image capture 325 may provide an option to the user to submit an attachment.

Image capture 325 may be selected by the user to upload a bill, stub, receipt, coupon or image.

Details 323 may include exit feature 327. Exit feature 327 may return the user to the accounts 303 page.

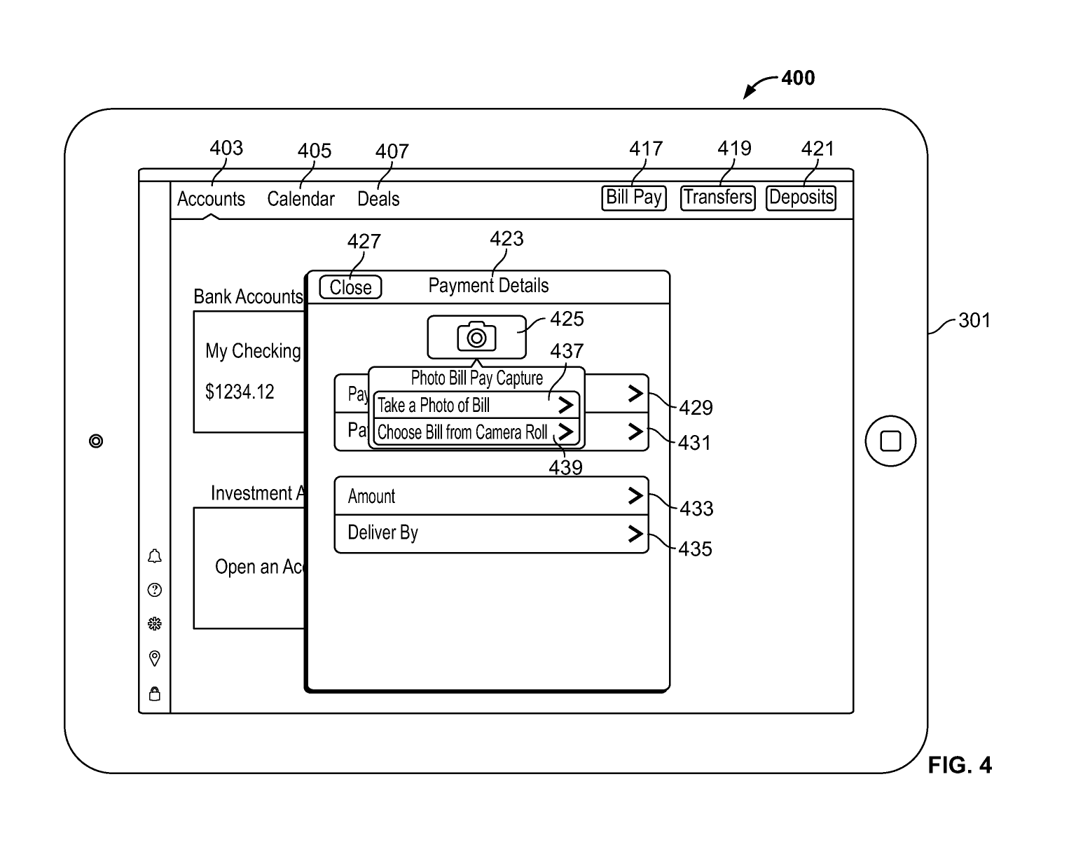

FIG. 4 shows illustrative display 400. Display 400 may be a GUI. Display 400 may be displayed using mobile device 401. Mobile device 401 may include some or all of the features of mobile devices 201 or 301.

Display 400 may include tabs 403, 405, 407, 409, 411, 413, 417, 419 and 421, which may include some or all of the features of tabs 203, 205, 207, 209, 211, 213, 217, 219 and 221, respectively.

Display 400 may include details 423, field 429, field 431, field 433, field 435 and exit feature 427, which may include some or all of the features of details 323, field 329, field 331, field 333, field 335 and exit feature 327.

Display 400 may include image capture 425. Image capture may be clicked, selected, or scrolled over. Image capture 425 may provide an option to capture billpay information. The information may be captured using a photograph.

Image capture 425 may include options 437 and 439.

Option 437 may be selected. The selection of option 437 may open a camera or photograph screen (not shown). Option 437 may capture a picture of an image.

Option 439 may be selected. Upon selection, option 439 may open a selection of photographs. The photographs may be chosen from a camera roll. The camera roll may be stored locally on the device. The camera roll may be stored remotely, in the cloud, or using any known storage solutions.

Option 439 may allow the user to select a photograph that has already been captured. The user may select an image/photograph of a bill.

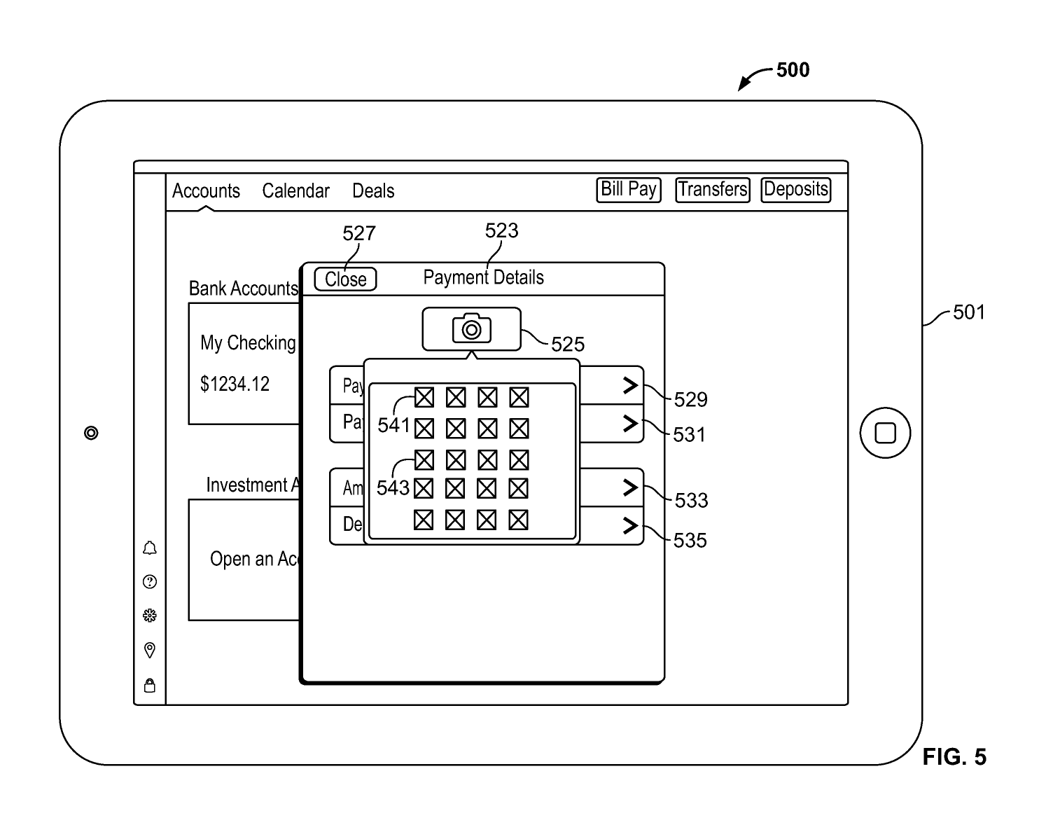

FIG. 5 shows illustrative display 500. Display 500 may be a GUI. Display 500 may be displayed using mobile device 501. Mobile device 501 may include some or all of the features of mobile devices 201, 301 and/or 401.

Display 500 may include one or more features of displays 200, 300 and/or 400.

Display 500 may include image capture 525. Image capture 525 may include one some or all of the features of image capture 425.

Image capture 525 may include photographs 541 and 543. Photographs 541 and 543 may be stored in memory. Photographs 541 and 543 may result from a user selection of one or both of options 437 and 439 discussed in FIG. 4.

For example, upon selection of option 437, the mobile device may capture an image. The image may be captured using a camera on the mobile device. The image may then be displayed as photograph 541.

In a further example, upon selection of option 439, the mobile device may retrieve the user's photographs. The user may select photograph 543. Photograph 543 may have been captured prior to the current session of online billpay.

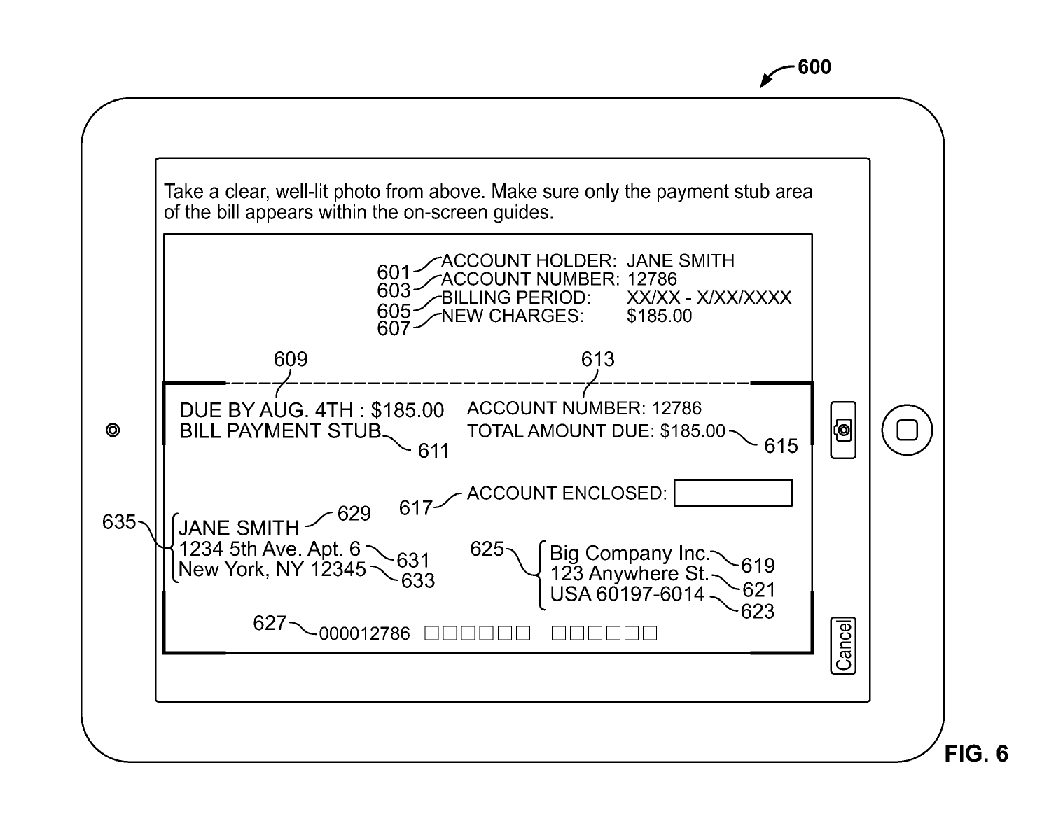

FIG. 6 shows illustrative display 600. Display 600 may include some or all of the features of display 500.

Display 600 may result from the selection of option 437, discussed in FIG. 4. Upon selection of option 437 to capture a photograph, billpay may access the camera feature. When the camera feature is accessed, the camera may display, using display 600, a real-time or substantially real-time image of a bill.

The image may be displayed on display 600. Illustrative bills displayed on display 600 may include one or more fields, such as account holder 601, account number 603, billing period 605, and new charges 607. These fields may be located on a paper bill. Display 600 may capture data corresponding to one or more of fields 601, 603, 605 and 607.

Display 600 may capture additional data. Display 600 may capture only a portion of the data from the bill. For example, on-screen guides (shown as bolded corners, may display a digital reference frame for display 600. The digital reference frame may define the boundaries of an image of the bill that is to be captured by the camera. For example, as shown in display 600, fields 601, 603, 605 and 607 are not within the digital reference frame. Therefore, data related to fields 601, 603, 605 and 607 may not be captured.

Data may be captured from one or more fields located within the digital reference frame. The on-screen guides for the digital reference frame may be configured to adjust the frame if perforated lines are present. The perforated lines may correspond to a boundary of a payment stub or coupon.

Data related to due date 609, bill type 611, account number 613, amount due 615, amount enclosed 617, payee information 625 (including payee name 619, payee address 621, and payee state and zipcode 623), account number 627 and payor information 635 (including payor name 629, payor address 631 and payor state and zipcode 633) may be captured as shown in display 600. The capture of the data may commence by the user selecting any suitable option for capturing a photograph.

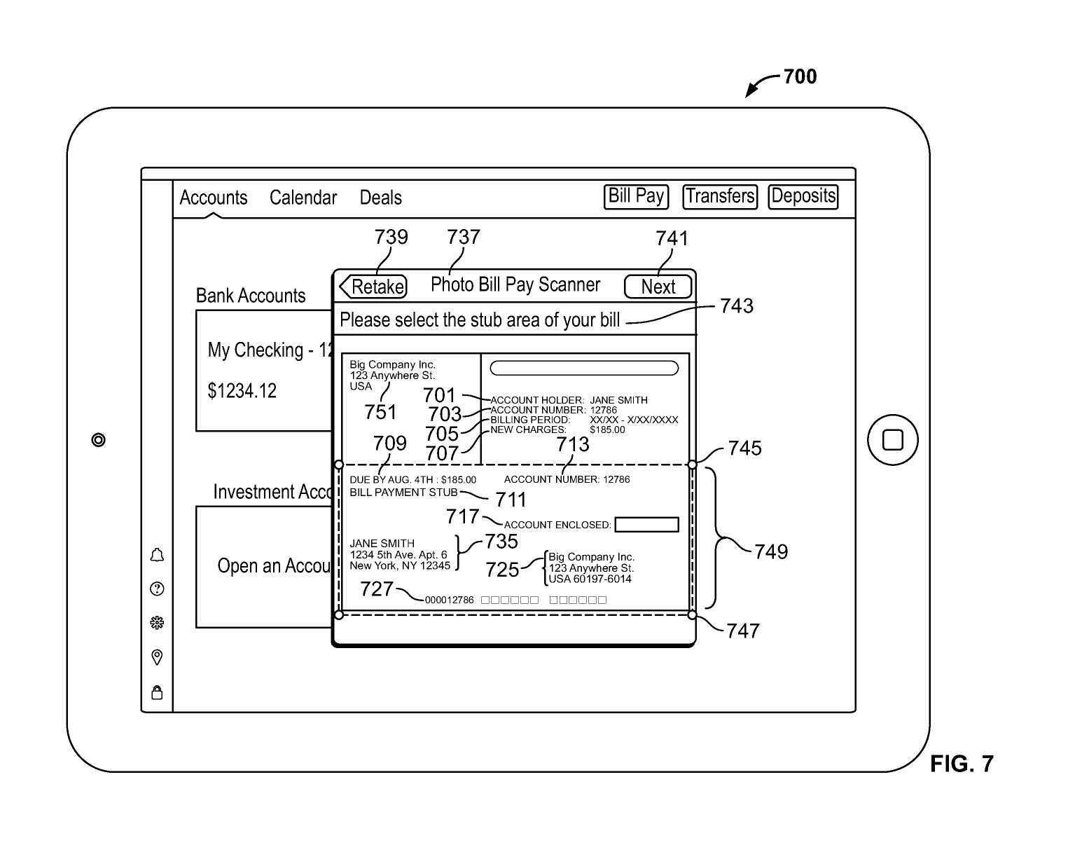

FIG. 7 shows display 700. Display 700 may include one or more of the features of FIGS. 1-6. Display 700 may include a finalized image of display 600. The image in display 700 may be a recorded and/or stored photograph after the image has been captured.

Display 700 may be overlayed on top of account information.

The image in display 700 may be a zoomed-out view of the image in display 600, prior to image capture.

Display 700 may include screenshot 737. Screenshot 737 may display the recently captured image.

Display 700 may include retake option 739. Option 739 may be selectable and/or clickable by a user. The user may select option 739 to return to display 600. The user may then re-capture the image. The user may then capture another image. Upon selection of option 739 the displayed information in one or both of displays 600 and 700, and/or the saved images, may be erased. Upon selection of option 739 the displayed information in one or both of displays 600 and 700, and/or the saved images, may be stored for later retrieval.

Display 700 may include option 741. Option 741 may display the next step in submission of the photo using online billpay.

Display 700 may include instructions 743. Instructions 743 may be any suitable instructions. For example, screenshot 737 may display a bill. Instructions 743 may instruct the user to select a portion of the bill. The portion of the bill may be selected on the image displayed in screenshot 737.

The portion of the bill as selected is shown using boundaries 749. Boundaries 749 may be a reference frame. Reference frame 749 may be set by the account. Reference frame 749 may be determined by an algorithm. For example, an algorithm may determine that the presence of perforations on the paper illustrates a boundary of the stub.

Boundaries 749 may be input by the user. For example, the user may select the boundaries of the stub. In a further example, the user may edit the boundaries of the stub. The user may edit the boundaries initially determined by the algorithm.

Reference frame 749 may include one or more of edges 745 and 747. Edges 745 and 747 may be used to adjust the reference frame. The edges may be clearly marked.

Display 700 may include one or more of fields 701, 703, 705, 707, 709, 711, 713, 717, 725, 727 and 739, which may include one or more features discussed in FIGS. 1-6.

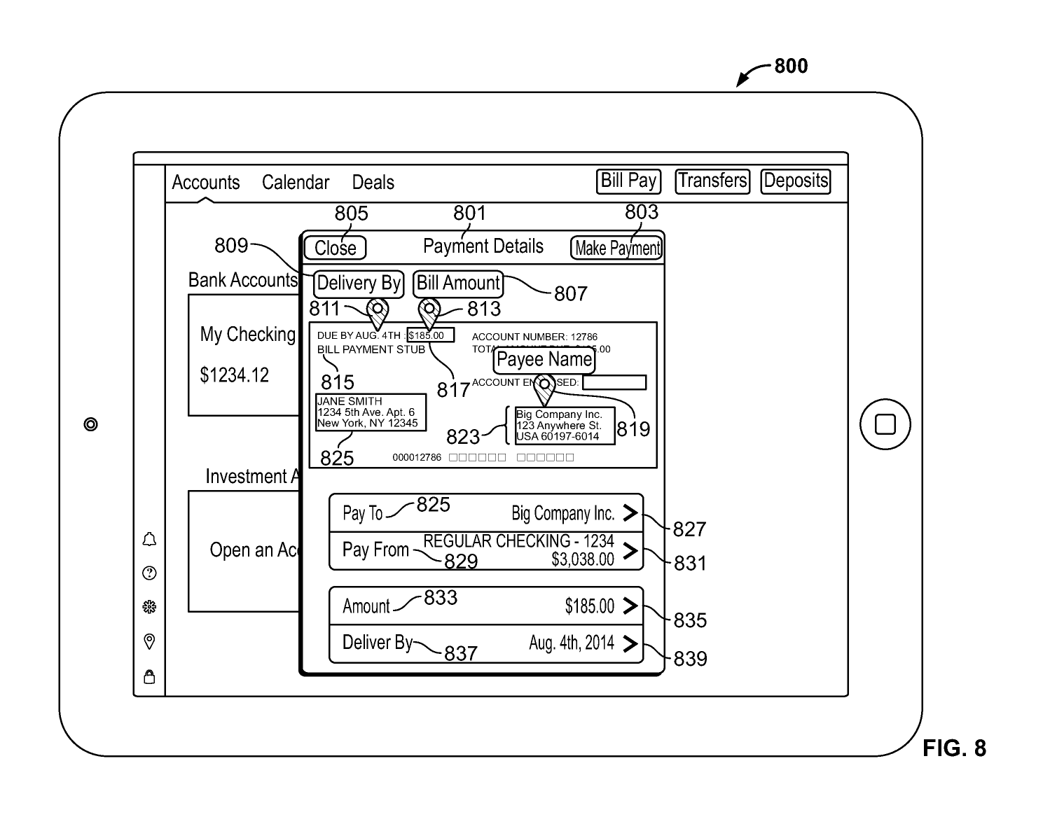

FIG. 8 shows illustrative display 800. Display 800 may be a GUI. Display 800 may be displayed to the user.

Display 800 may include payments details 801. Payment details 801 may display a tagged image of a payment stub.

Details 801 may include clickable options 803 and 805. Option 803 may be clicked to proceed with payment. Option 805 may be clicked to close details 801. When option 805 is selected, details 801 may be saved for later retrieval. When option 805 is selected, details 801 may be erased.

Details 801 include drag-and-drop icons 807 and 809. Icons 807 and 809 may be any suitable icon or identifier. Icons 807 and 809 may be used to identify any suitable billpay field.

For example, icon 807 may be an icon for bill amount. Icon 807 may be selected the user. Icon 807 may be dragged by the user to a billpay field located within the payment stub image. For example, icon 807 may be dragged by the user to the location of the bill amount field in the image of stub, noted as field 817.

Field 817 may be a billpay field. It should be noted that the tool may recognize field 817 as a billpay field. The tool may not recognize field 817 as a billpay field. The tool may recognize that field 817 is a billpay field, but may not recognize the type or specific billpay field (i.e. bill amount).

The user may drag icon 807 over field 817. The user may “drop”, click, paste or otherwise indicate that icon 807 is associated with field 817.

The association may be visually identified using tag 813. Tag 813 may be displayed after field 817 is identified as the bill amount field. Tag 813 may be tagged to the payment stub. Tag 813 may be a bill amount tag.

Upon the association of icon 807 with field 817, the icon may be linked or electronically tagged. Tag 813 may be a visual indicator or representation of the electronic link.

Details 801 may also include one or more tags identified by the tools. For example, the tools may recognize a billpay field. The tools may recognize images or text. The tools may recognize characters, symbols or logos.

The tools may recognize text and/or characters for a billpay field based on pattern recognition, prior transactions, or databases.

For example, field 823 may be a payee name field. The tool may recognize characters, text, images and/or patterns within field 823. The tool may tag field 823 with tag 819. Tag 819 may be linked to field 823.

The tool may tag field 823 based on computer recognition. Upon viewing details 801, the user may already see field 823 tagged with tag 819.

Details 801 may include one or more of payee field 825, payor field 829, amount 833 and deliver by 837. Fields 825, 829, 833 and 837 may be fillable fields. For example, the fields may be filled with relevant billpay information.

The billpay information may be input by the user. A portion of the billpay information may be input by the user.

The billpay information may be retrieved from a captured image. For example, amount field 833 may be associated with field 835. Field 835 may be a part of amount field 833. Field 835 may be a fillable field. Field 835 may be fillable with the amount due.

Amount field 835 may be filled with one more characters, text or glyphs. The characters may be retrieved from an image. The characters may be a group of characters.

Amount fields 833 and/or 835 may be coupled with one or more tags. For example, amount fields 833 and/or 835 may be coupled with tags that correspond to amount information. For example, amount fields 833 and/or 835 may be coupled with tag 813. Tag 813 may be an amount due tag. Tag 813 may be the designated tag coupled with amount fields 833 and/or 835.

The tool may attempt to retrieve an amount to fill amount field 835. The tool may determine which tag is coupled with field 835.

The tool may determine that tag 813 is coupled with tag 835. The tool may determine if tag 813 is linked to, or associated with, a field on the image. The tool may determine if tag 813 has already been assigned to a location upon the image.

If the tag has not been assigned to a location, or has not been used to tag, the tool may determine that characters are not available to automatically populate the field. Field 835 may remain blank and/or fillable for the user.

If the tag has been assigned a location and/or has been used to tag an image, the tool may determine the corresponding text. The tool may determine if the text has been translated in computer-readable text. For example, the tool may determine if the text 817 associated with tag 813 has been translated.

If the text has not been translated, the tool may translate the text into one or more characters. If the text has been translated, the tool may extract, retrieve or copy the characters into field 835.

It should be noted that information displayed in display 800 and/or details 801 may be displayed prior to and/or subsequent to translation of indecipherable text.

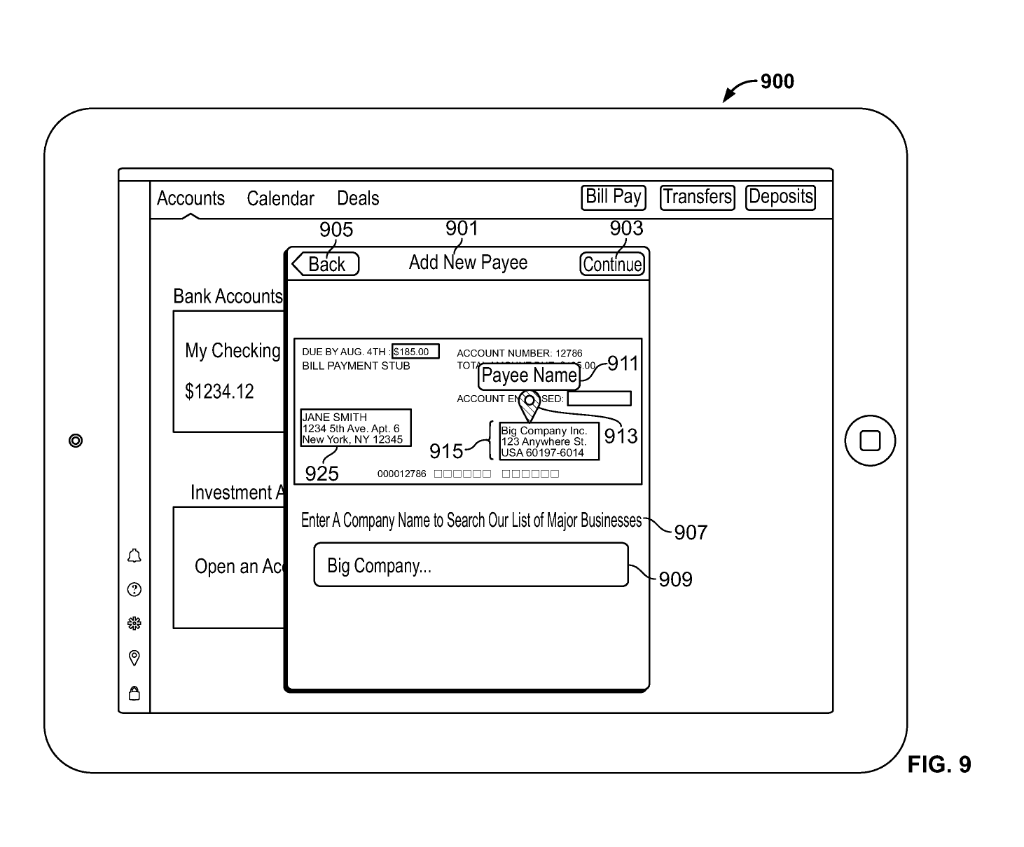

FIG. 9 shows illustrative display 900. One or more of 901, 903 and 905 may include one or more features of FIGS. 1-8.

Display 900 may include drag-and-drop tile 911. Tile 911 may be dragged and dropped to payee name field 915. Based on the dragging and dropping of tile 911 to payee name field 915, tile 911 may be associated with payee field 915.

Payee field 915 may be tagged with tag 913. Tag 913 may represent a link between payee field 915 and tile 911. Tag 913 may be a visual indicator of a link.

Payee field 915 may include text that is not recognized by the billpay program. For example, field 915 may be tagged with tag 913. The text in payee field 915 may be translated.

The tool may attempt to recognize the name of the payee. The tool may not be able to identify or recognize the name of the payee. The tool may recognize the characters of the name of the payee, but display to the user that the payee name has not been used on the account before.

Field 909 may be a searchable field or a drop down menu. Field 909 may display one or more known payees. The payee may be known to the tool based on prior activity of the user. The payee may be known to the based on a comprehensive database of payees. Field 909 may be filled with the payee name from field 915.

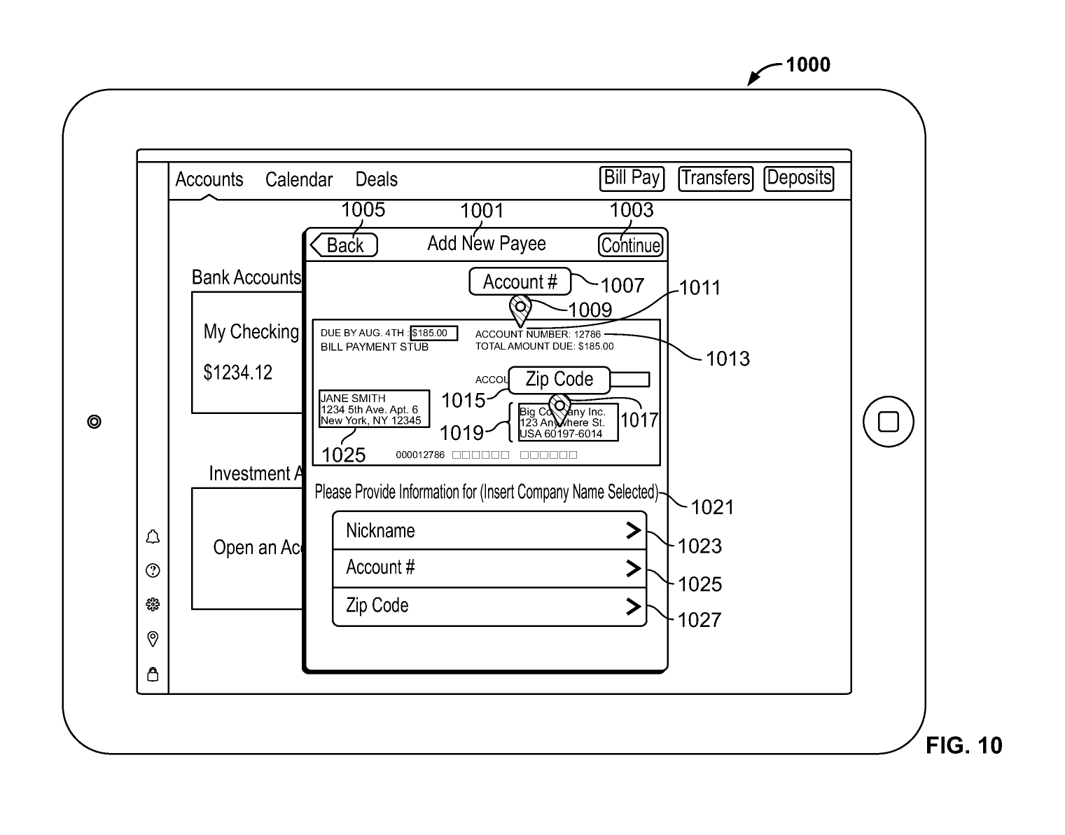

FIG. 10 shows illustrative display 1000. Display 1000 may include one or more features of FIGS. 1-9.

Display 1000 may display an image of a paystub. The paystub may include one or more fields that have been tagged. The tag may be a user tag.

The paystub may include one or more fields that are not recognizable. The paystub may include one or more fields that are not identifiable for this account.

For example, tag 1017 may be associated with the zip code in payee address. The tool may be unable to recognize the zip-code characters. The zip-code characters may not be able to populate zip-code field 1027.

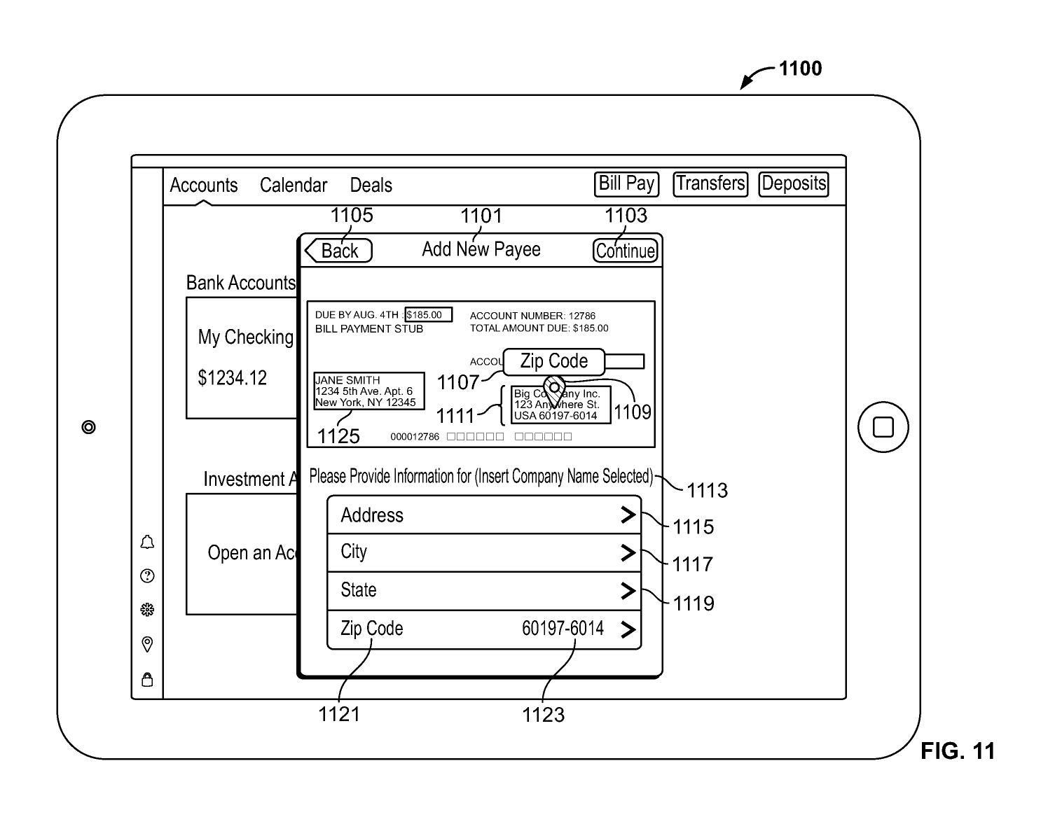

FIG. 11 shows illustrative display 1100.

Display 1100 may include one or more fields.

The zip-code in payee address field 1111 may be tagged with tag 1109. The tag may be linked with fields 1121 and/or 1123.

Based on the link, the tool may determine that text from field 1111 is appropriate for populating field 1123. The tool may attempt to populate field 1123 with the zip-code.

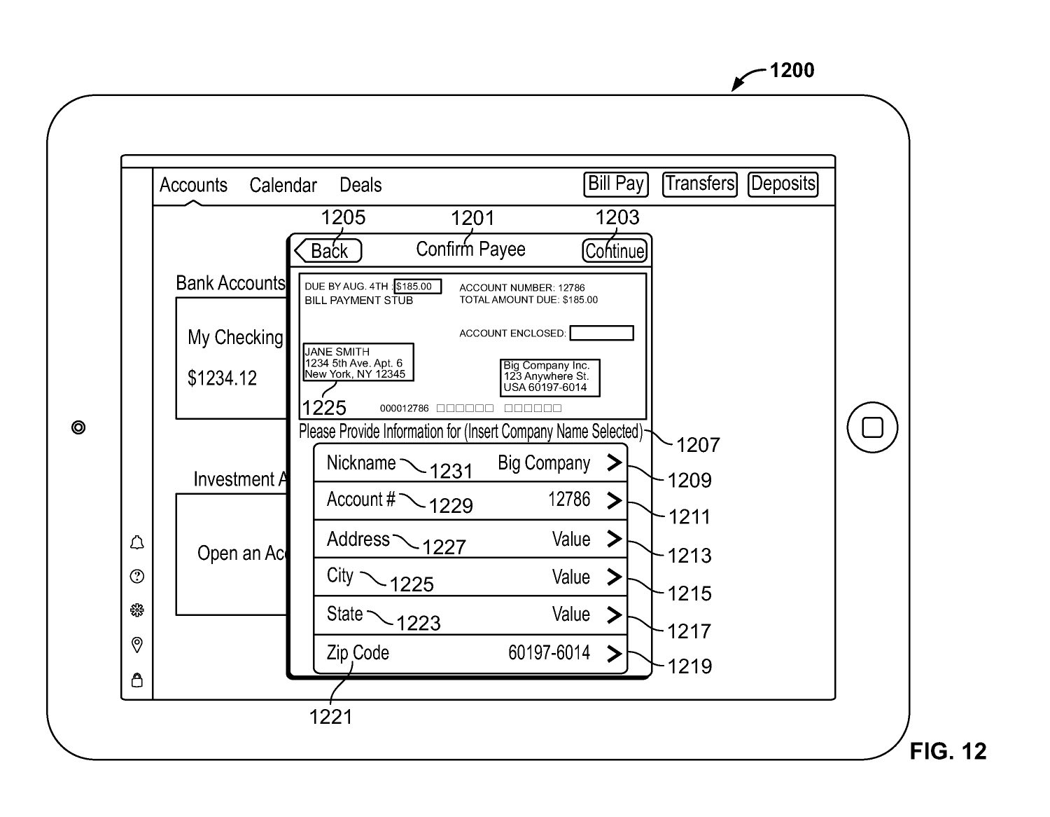

FIG. 12 shows illustrative display 1200. Display 1200 may display one or more tagged billpay fields.

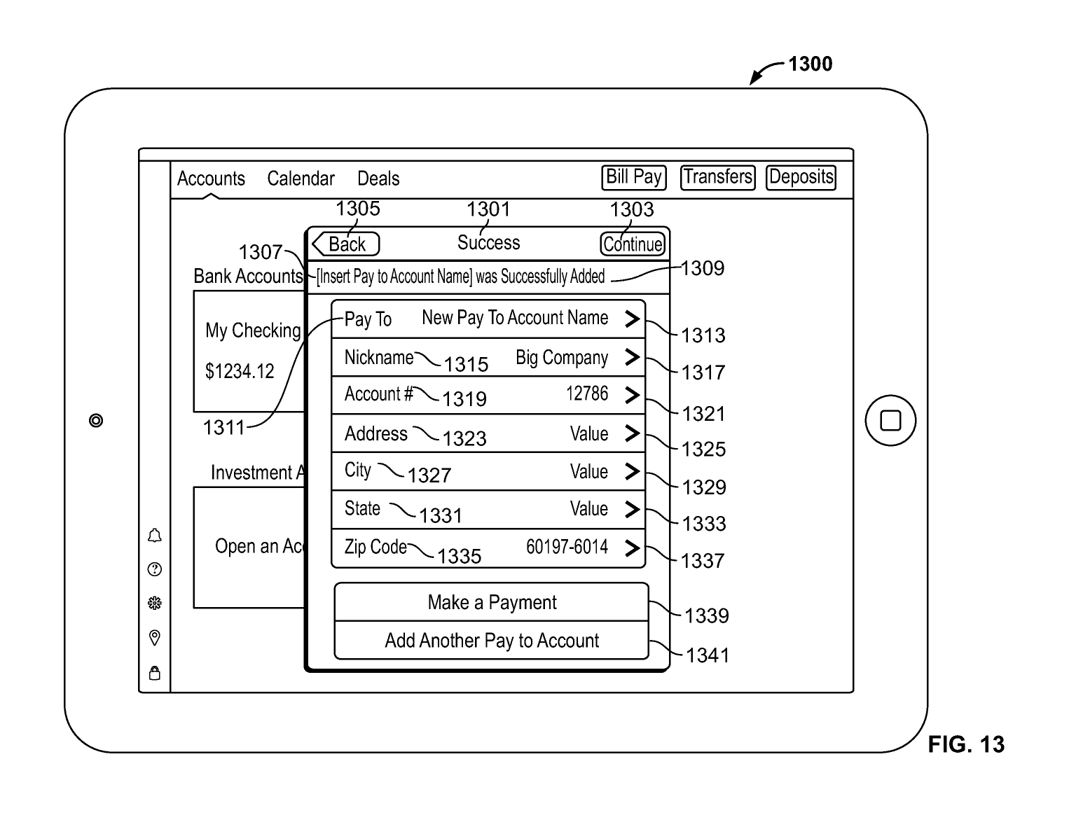

FIG. 13 shows illustrative display 1300.

Display 1300 may include one or more populated bill input fields, such as field 1317, field 1321 and field 1337.

The unpopulated billpay fields may be manually filled by a user. For example, the user may type in the address to field 1325.

The unpopulated billpay fields may be subsequently populate at the direction of the user. For example, the user may select back button 1305. The user may return to an image of the bill. The user may designate a location on the image. The location may be the city of the payor.

The user may use a drag-and-drop tile to designate the text at that location as the city of the payor. The tile may be linked with unpopulated field 1329. Unpopulated field 1329 may be populated with the text associated with the tagged location.

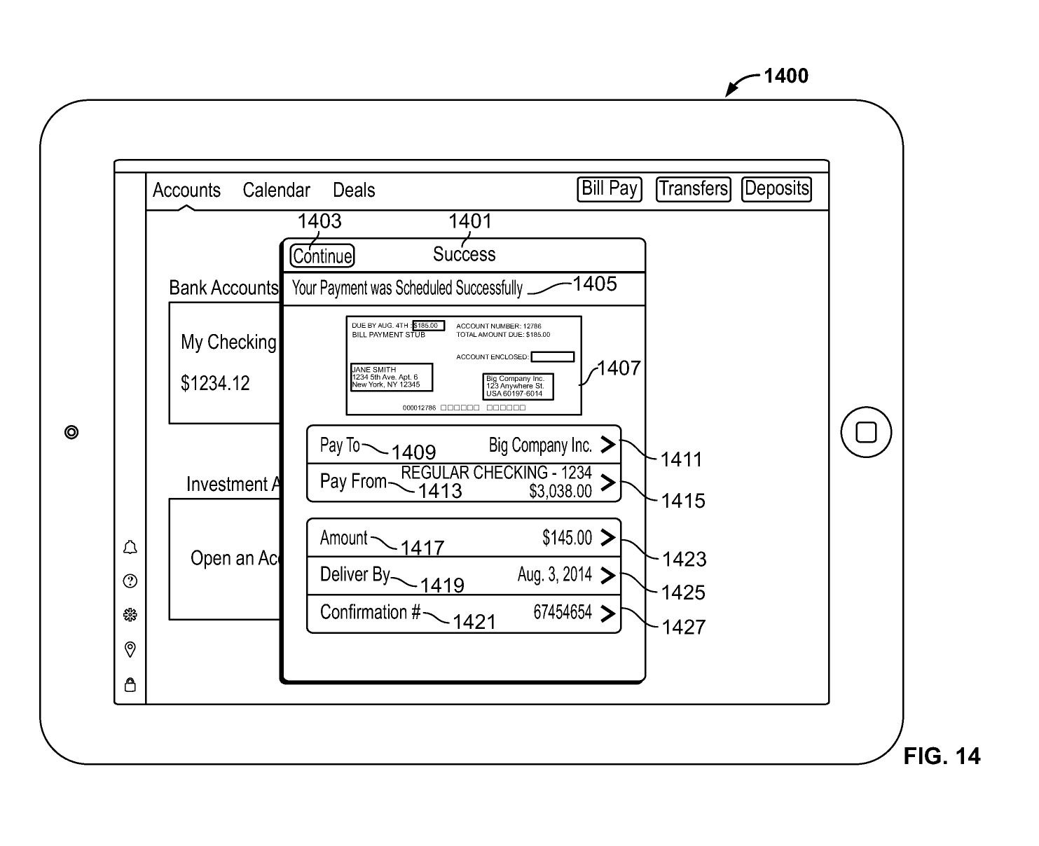

FIG. 14 shows illustrative display 1400.

Display 1400 shows image 1407. Image 1407 may not include visible tags.

Display 1400 may include billpay fields that are all successfully populated.

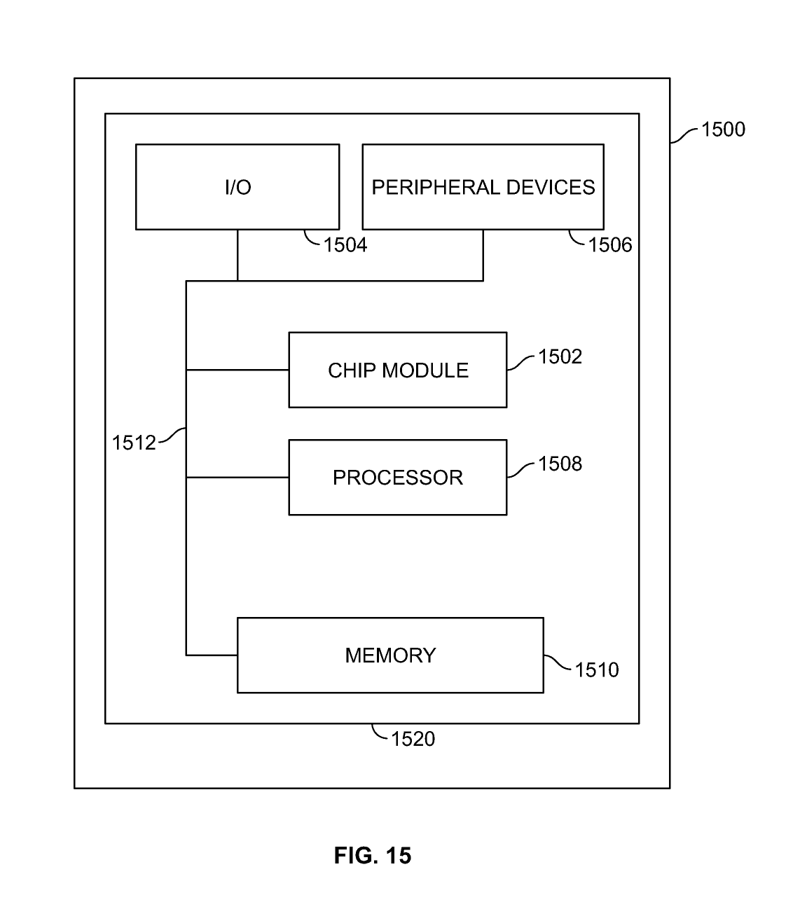

FIG. 15 shows illustrative apparatus 1500.

Apparatus 1500 may share one or more features with a computing machine. Apparatus 1500 may be included in apparatus shown in FIG. 1. Apparatus 1500 may include chip module 1502, which may include one or more integrated circuits, and which may include logic configured to perform any other suitable logical operations.

Apparatus 1500 may include one or more of the following components: I/O circuitry 1504, which may include the transmitter device and the receiver device and may interface with fiber optic cable, coaxial cable, telephone lines, wireless devices, PHY layer hardware, a keypad/display control device or any other suitable encoded media or devices; peripheral devices 1506, which may include counter timers, real-time timers, power-on reset generators or any other suitable peripheral devices; logical processing device 1508, which may compute data structural information, structural parameters of the data, quantify indicies; and machine-readable memory 1510.

Machine-readable memory 1510 may be configured to store in machine-readable data structures: data lineage information; data lineage, technical data elements; data elements; business elements; identifiers; associations; relationships; and any other suitable information or data structures.

Components 1502, 1504, 1506, 1508 and 1510 may be coupled together by a system bus or other interconnections 1512 and may be present on one or more circuit boards such as 1520. In some embodiments, the components may be integrated into a single silicon-based chip.

It will be appreciated that software components including programs and data may, if desired, be implemented in ROM (read only memory) form, including CD-ROMs, EPROMs and EEPROMs, or may be stored in any other suitable computer-readable medium such as but not limited to discs of various kinds, cards of various kinds and RAMs. Components described herein as software may, alternatively and/or additionally, be implemented wholly or partly in hardware, if desired, using conventional techniques.

Various signals representing information described herein may be transferred between a source and a destination in the form of electromagnetic waves traveling through signal-conducting encoded media such as metal wires, optical fibers, and/or wireless transmission encoded media (e.g., air and/or space).

Apparatus 1500 may operate in a networked environment supporting connections to one or more remote computers via a local area network (LAN), a wide area network (WAN), or other suitable networks. When used in a LAN networking environment, apparatus 1500 may be connected to the LAN through a network interface or adapter in I/O circuitry 1504. When used in a WAN networking environment, apparatus 1500 may include a modem or other means (not shown) for establishing communications over the WAN. It will be appreciated that the network connections shown are illustrative and other means of establishing a communications link between the computers may be used. The existence of any of various well-known protocols such as TCP/IP, Ethernet, FTP, HTTP and the like is presumed, and the system may be operated in a client-server configuration to permit a user to operate logical processing device 1508, for example over the Internet.

Apparatus 1500 may be included in numerous general purpose or special purpose computing system environments or configurations. Examples of well-known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, tablets, programmable consumer electronics, network PCs, minicomputers, mainframe computers, distributed computing environments that include any of the above systems or devices, and the like.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones and/or other personal digital assistants (“PDAs”), multiprocessor systems, microprocessor-based systems, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage encoded media including memory storage device.

One of ordinary skill in the art will appreciate that the elements shown and described herein may be performed in other than the recited order and that one or more elements illustrated may be optional. The methods of the above-referenced embodiments may involve the use of any suitable elements, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems or methods for photograph billpay tagging are therefore provided. Persons skilled in the art will appreciate that the present invention can be practiced by other than the described embodiments, which are presented for purposes of illustration rather than of limitation, and that the present invention is limited only by the claims that follow.

What is claimed is:

1. A method comprising:
receiving a digital image, said digital image corresponding to a portion of text positioned upon a medium, said text corresponding to billpay information;
defining a graphical reference frame for the digital image;
identifying a set of glyphs within the text;
translating, into a group of estimated characters, via an electronic algorithm implemented by a processor, a portion of the digital image within the reference frame, said portion of the digital image corresponding to at least a part of the set of glyphs;
tagging said portion of the digital image with a tag;
coupling the tag with a billpay input field; and
based on the coupling, populating the billpay input field with the group of estimated characters.

2. The method of claim 1 wherein, when the billpay input field is populated, the method further comprises displaying, to a user, the populated input field on a user interface.

3. The method of claim 1 wherein, when:
the portion of the digital image is a first portion of the digital image;
the estimated group of characters is a first group of estimated characters;
the tag is a first tag; and
the billpay input field is a first billpay input field;
the method further comprises:
translating a second portion of the digital image into a second group of estimated characters;
tagging the second portion of the digital image with a second tag.
coupling the second tag with a second billpay input field; and
based on the coupling of the second tag with the second billpay input field, populating the second billpay input field with the second group of estimated characters.

4. The method of claim 1 wherein the tagging comprises:
selecting one or more glyphs of the set of glyphs within the text, a segment of the portion of the digital image corresponding to the selected glyphs;
electronically highlighting the segment, said highlighting displayed on a user interface, said segment corresponding to at least a portion of the group of estimated characters; and
establishing an electronic link between the segment and the portion of the group of estimated characters, said link corresponding to the tag.

5. The method of claim 4 wherein:
the electronic link is a first electronic link;
the coupling comprises:
establishing a second electronic link between the tagged segment and the billpay input field; and
associating the first electronic link and the second electronic link; and
the populating comprises filling the billpay input field with the portion of the group of estimated characters.

6. The method of claim 1 wherein the billpay input field is determined based on the group of estimated characters.

7. The method of claim 1 wherein, when the billpay input field is a first billpay input field and the first billpay input field corresponds to an error, the method further comprises:
receiving a second billpay input field, said second billpay input field selected to correct the error;
de-coupling the tag from the first billpay input field;
based on the de-coupling, removing the group of estimated characters from the first billpay input field;
coupling the tag to the second billpay input field; and
based on the coupling of the tag to the second billpay input field, inserting the group of estimated characters associated with the tag.

8. The method of claim 1 wherein, when the billpay input field is a first billpay input field, the method further comprises:
receiving, from a user, a correction, said correction corresponding to selection of the first billpay input field; and
based on the correction, selecting a second billpay input field.

9. The method of claim 1 further comprising:
receiving, from a user, a correction, said correction corresponding to the group of estimated characters, and
based on the correction, adjusting at least one of the group of estimated characters.

10. An apparatus comprising:
a receiver configured to receive a digital image, said digital image corresponding to a portion of text positioned upon a medium, said text corresponding to billpay information;
a processor configured to:
define a graphical reference frame for the digital image;
identify a set of characters within the text;
translate, into a group of estimated characters, via an electronic algorithm implemented by the processor, a portion of the digital image within the reference frame, said portion of the digital image corresponding to at least a part of the set of characters;
tag said portion of the digital image with a tag;
couple the tag with a billpay input field; and
a transmitter configured to transmit, based on the billpay input field being coupled with the tag, an instruction; and
the receiver further configured to receive the instruction, the instruction comprising an instruction to populate the billpay input field with the group of estimated characters.

11. The apparatus of claim 10 further configured to display, to a user, the populated billpay input field.

12. The apparatus of claim 10 wherein, the portion of the digital image is a first portion of the digital image, the estimated group of characters is a first group of estimated characters, the tag is a first tag and the billpay input field is a first billpay input field, the apparatus further comprises:
the processor further configured to:
translate a second portion of the digital image into a second group of estimated characters;
tagg the second portion of the digital image with a second tag.
couple the second tag with a second billpay input field; and
based on the coupling of the second tag with the second billpay input field; and
the transmitter further configured to transmit an instruction to populate the second billpay input field with the second group of estimated characters.

13. The apparatus of claim 10 wherein the tagging further comprises:
the processor further configured to:
select, when a segment of the portion of the digital image corresponds to the selected characters, one or more characters of the set of characters within the text;
electronically highlight the segment, said highlighting configured to be displayed on a user interface, said segment corresponding to at least a portion of the group of estimated characters; and
establish an electronic link between the segment and the portion of the group of estimated characters, wherein the electronic link corresponds to the tag.

14. The apparatus of claim 13 wherein, when the electronic link is a first electronic link the coupling comprises:
the processor further configured to:
establish a second electronic link between the tagged segment and the billpay input field; and
associate the first electronic link with the second electronic link; and
the transmitter further configured to:
transmit an instruction to populate the billpay input field with the portion of the group of estimated characters.

15. The apparatus of claim 10 wherein the billpay input field is determined based on the group of estimated characters.

16. The apparatus of claim 10 wherein, when the billpay input field is a first billpay input field, the apparatus further comprises:
the receiver further configured to receive:
an error notification, said error notification corresponding to an error associated with the first billpay input field; and
based on the error, a second billpay input field selection, said second billpay input field being selected to correct the error; and
the transmitter further configured to transmit instructions to:
de-couple the tag from the first billpay input field;
based on the de-coupling, remove the group of estimated characters from the first billpay input field;
couple the tag to the second billpay input field; and
based on the coupling of the tag to the second billpay input field, insert the group of estimated characters associated with the tag.

17. The apparatus of claim 10 wherein, when the billpay input field is a first billpay input field, the apparatus further comprises:
the receiver further configured to receive, from a user, a correction, the correction corresponding to the selection of the first billpay input field; and
based on the correction, the transmitter further configured to transmit an instruction to select a second billpay input field.

18. The apparatus of claim 10 further comprising:
the receiver further configured to receive, a correction, said correction corresponding to the group of estimated characters, and
the transmitter further configured to transmit an instruction to adjust, based on the correction, at least one of the group of estimated characters.

19. A method comprising:
receiving a digital image, said digital image corresponding to a portion of text positioned upon a medium, said text corresponding to billpay information;
defining a graphical reference frame for the digital image;
identifying a set of characters within the text;
translating, into a group of estimated characters, via an electronic algorithm implemented by a processor, a portion of the digital image within the reference frame, said portion of the digital image corresponding to at least a part of the set of characters;
tagging said portion of the digital image with a tag;
coupling the tag with a billpay input field; and
based on the coupling, populating the billpay input field with the group of estimated characters.
